(19) United States
(12) Patent Application Publication
(10) Pub. No.: US 2014/0340889 A1
(43) Pub. Date: Nov. 20, 2014

(54) APPARATUS, SYSTEM, AND METHODS FOR GLARE REDUCTION AND UPLIGHTING FOR GOLF COURSE, SPORTS FIELDS AND LARGE AREA LIGHTING

(71) Applicant: Musco Corporation, Oskaloosa, IA (US)

(72) Inventor: Myron Gordin, Oskaloosa, IA (US)

(73) Assignee: Musco Corporation, Oskaloosa, IA (US)

(21) Appl. No.: 14/282,742

(22) Filed: May 20, 2014

Related U.S. Application Data
(60) Provisional application No. 61/825,370, filed on May 20, 2013.

(51) Int. Cl. F21K 99/00; F21V 13/04

(52) U.S. Cl. CPC F21K 9/58; F21V 13/04
USPC 362/231; 362/235; 362/257; 362/296.01; 362/307; 362/308; 362/311.02

(57) ABSTRACT

An apparatus, system and method for glare reduction and effective lighting, including uplighting for such things as sports fields including golf courses or for other large area projects. A set of solid state light sources having an original perceived intensity from viewers and an original light output, are altered to be perceived by a viewer as a larger light source to reduce glare to the viewer. This alteration can occur when a number of techniques including diffusive or reflective surfaces in the original output of the light sources. Altered light output is further modified by either cutting portions of it off or redirecting portions of it for more effective use. For example, a visor with reflective surface can redirect light either to a target area or for uplighting. This allows concurrent benefits of glare reduction for viewers of the sources or effective use of light.

### CROSS-REFERENCE TO RELATED APPLICATIONS

This application claims priority under 35 U.S.C. §119/35 U.S.C. §120 to provisional U.S. application Ser. No. 61/825,370, filed May 20, 2013, hereby incorporated by reference in its entirety.

### BACKGROUND OF INVENTION

1. Field of Invention

Some embodiments of the present invention generally relate to lighting systems. More specifically, some embodiments of the present invention relate to LED and other solid-state lighting fixtures and devices.

2. Background

LEDs are becoming increasingly popular in sports and wide area lighting, but there are concerns. One concern is the intensity of LED lighting when viewed by observers. In order to understand the significance of this concern, it is necessary to understand how a target area, such as a sports field, is illuminated. Any target area needs a specific amount of light to fall on it. This light may come from a pinpoint source, such as one or more LEDs, or it can come from a diffuse source, such as light from the sky on a cloudy day where the sun is obscured. In the case of a pinpoint source, it can be very unpleasant to look at, since the ratio between source intensity and target intensity is very high. When this ratio is very high, it actually reduces the perception of light on the target area or field, which then seems to require more light on the field, resulting in potentially very high light levels but poor actual visibility and light quality.

A second, related, concern with the use of LEDs for lighting is the possible need for uplighting. In many sports, such as baseball, football, and golf, sometimes the ball will be high in the air, requiring good illumination for players and spectators to be able to see the ball in the air. This is not a problem for daylight play, and is not too hard to do using conventional lighting such as HID light sources, since those types of sources tend to spill a lot of light, sufficient to provide uplighting, even when the lights are aimed down on the field. Also, conventional lighting provides uplighting by reflection from field. Not much is required since the night background is essentially black. However, there is a limit to the height (e.g. from ground level) that can be illuminated by reflected light. Further, improved lighting and glare control of modern lighting, especially LED lighting, can inadvertently reduce uplight, since downlighting that is highly targeted to the field and which provides adequate but not excessive levels of “ground level” uplighting provides little or no uplighting in the “fly zone” (space above the ground) reflective lighting zone. At the same time, attempting to increase uplight can create unwanted glare due to the intensity of LED lighting. The issues of uplighting in general are discussed in depth in U.S. patent application Ser. No. 12/939,838, which is hereby incorporated by reference in its entirety. Uplighting problems with LED lighting in particular is exacerbated by attempting to use LED lighting that targets the “fly zone.” This type of lighting can create glare, since glare is perceived based on intensity of light source. Each LED is a very small (relative to most large area light sources), intense light source, which creates more glare than a larger, less intense light source for the same level of illumination on the field or target area. There is therefore room for improvement in the art.

### SUMMARY OF THE INVENTION

Given intensity and uplighting needs, embodiments of the invention as envisioned improve on or advance the state of the art. In particular, embodiments provide unexpected combination of benefits, such as an unexpected increase in lighting effectiveness and unexpected reduction in glare.

One of the problems in the art is the intensity and/or glare that can be produced by LED lighting. It is known in the art that adding additional light sources around intense LED light sources can reduce the perception of glare, possibly since a larger light source will tend to increase the human eye's adaptation to light. Likewise, for a target illuminated to a given intensity, if the source is larger, the source intensity is lower and therefore glare is reduced.

Embodiments according to aspects of the invention provide innovative, valuable, and unexpected benefits.

Some embodiments according to aspects of the invention use reflectors, visors, or surrounds which reflect light from LEDs, thereby increasing perceived size of light source. This results in several benefits, such as significantly increased light to the target, reduced light intensity needed from a light source since more light is captured, and/or reduced glare since the reflector or other component or surface(s) acts as a visor.

Further embodiments according to aspects of the invention use one or more diffusing reflectors, visors, or surrounds to redirect lighting from visible LED sources to increase light on a given target area.

Further embodiments according to aspects of the invention use one or more diffusing reflectors, visors, or surrounds to redirect lighting from hidden or partially hidden LED sources to increase light on a given target area.

Further embodiments according to aspects of the invention use diffusing lens material to intercept some, most, or all light from LED light sources. Benefits of these embodiments can include reducing perceived glare and allowing benefits such as less glare, better placement of light sources relative the field, improved light cut off, and improved uplight.

Further embodiments according to aspects of the invention use partially diffused LED light sources to create lighting zones which provide intense lighting on some areas and diffused lighting on other areas.

Further embodiments according to aspects of the invention use partially diffused LED light sources to provide uplight to a fly zone that is reduced in harshness compared to undiffused lighting.

Further embodiments according to aspects of the invention provide LED lighting for target areas such as sports fields and golf courses which provide adequate downlighting and adequate uplighting without excessive glare, by diffusing some or all of the light from a fixture using LED light sources.

Further embodiments according to aspects of the invention provide LED lighting for downlighting and uplighting on golf courses which provides a low but sufficient level of downlighting with a low but sufficient level of uplighting and having low level of glare and reduced harshness.

Further embodiments according to aspects of the invention provide LED lighting with different color or color temperatures for downlighting and for uplighting.

Further embodiments according to aspects of the invention reduce the relative amount of light directly visible from an LED source while maintaining approximately the same designed amount of light from the fixture with associated reflective visors or surrounds.

Further embodiments according to aspects of the invention reduce energy required to illuminate a target area while maintaining an adequate or improved actual or perceived level of illumination by increasing the amount of light directed to a target area from an LED fixture while maintaining or reducing the light intensity viewed from the target area.

Further embodiments according to aspects of the invention provide LED lighting with diffusing reflectors, visors, or surrounds which act as a source of on the order of 50% to 5% of the light emitted by the fixture, thereby reducing perceived glare while providing adequate or improved levels of light.

### ILLUSTRATIONS

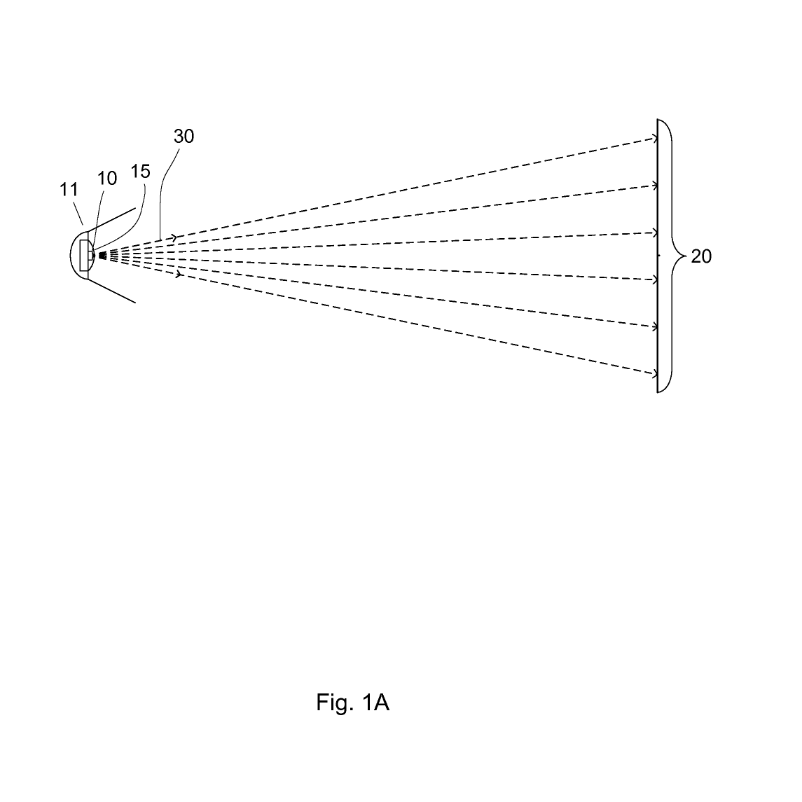

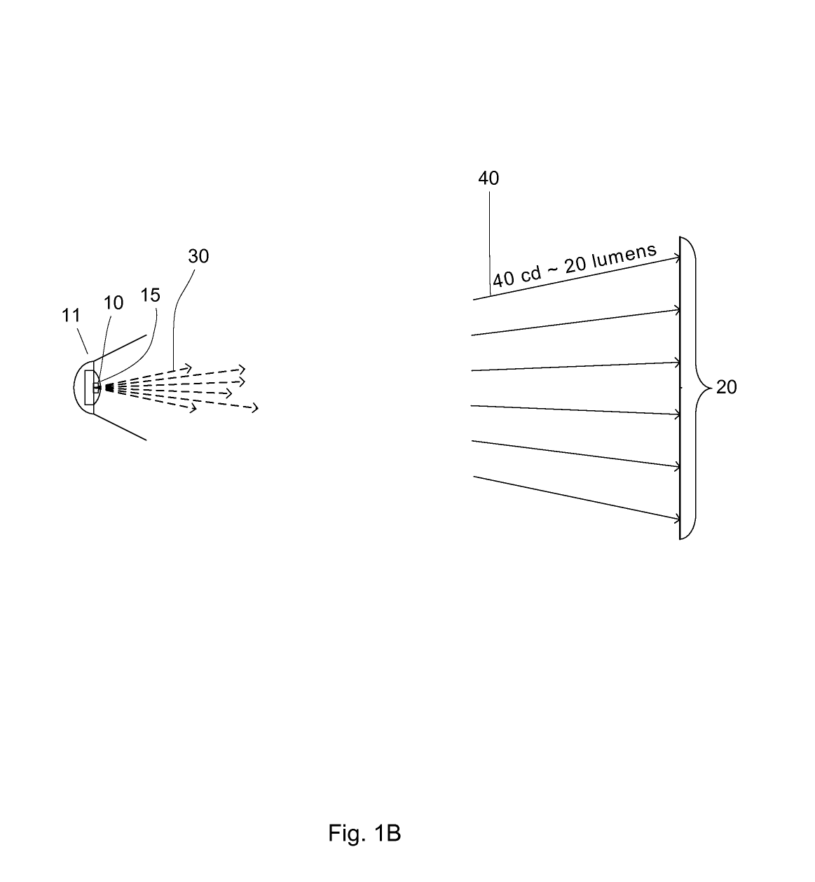

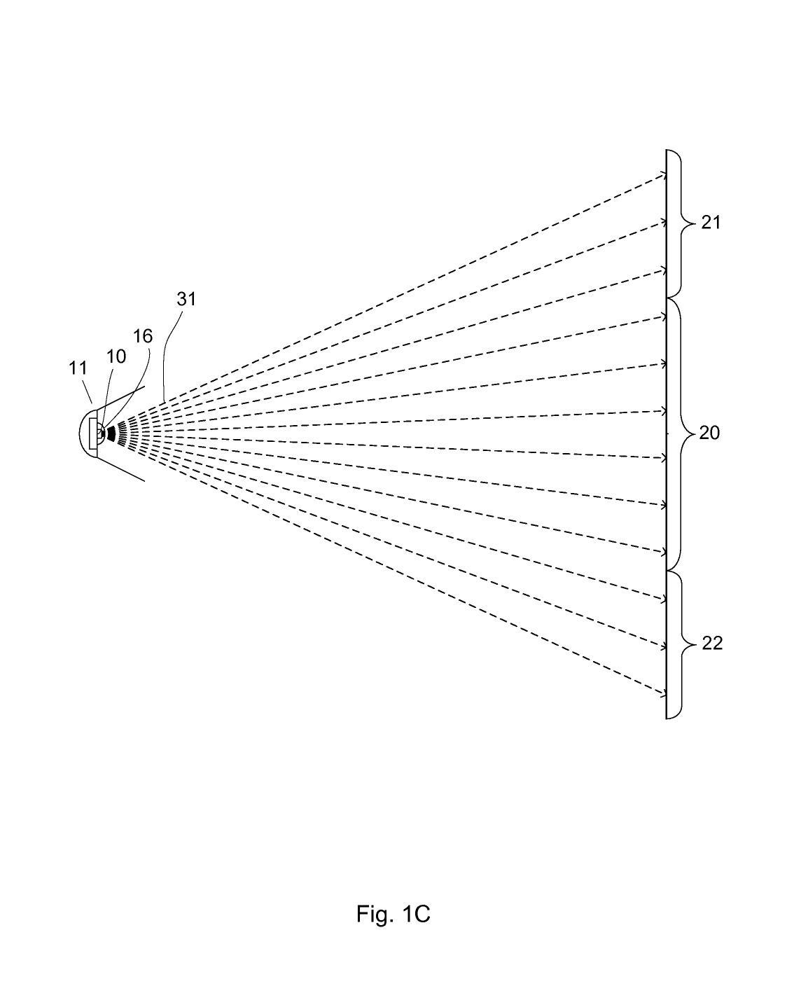

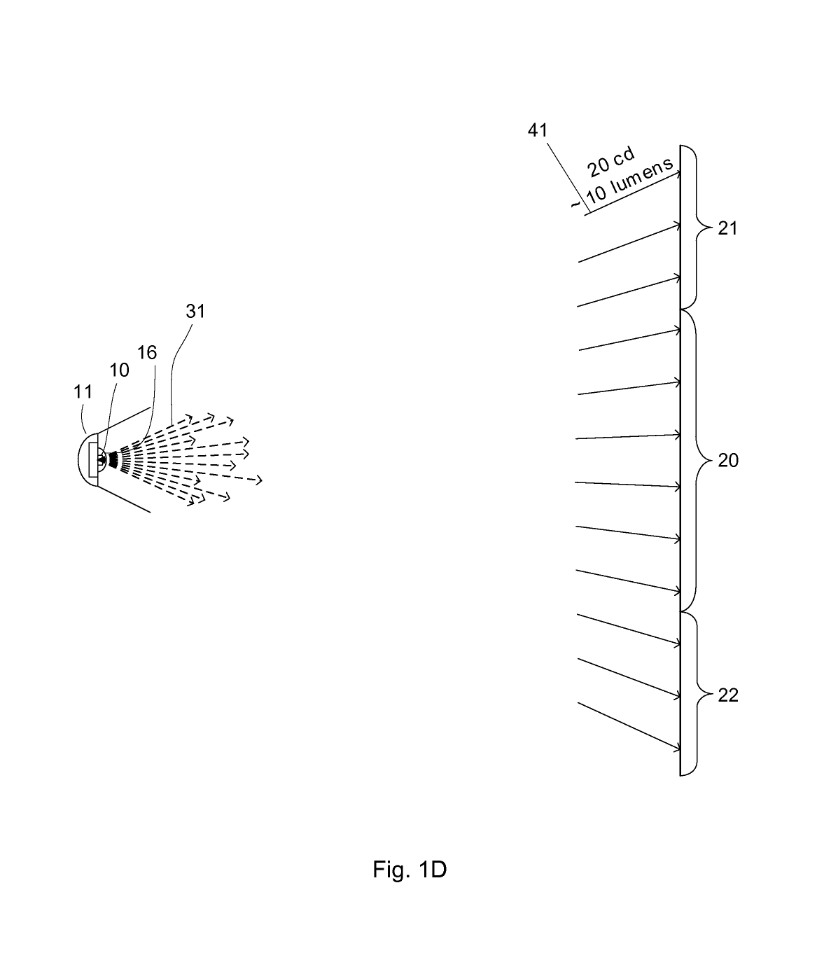

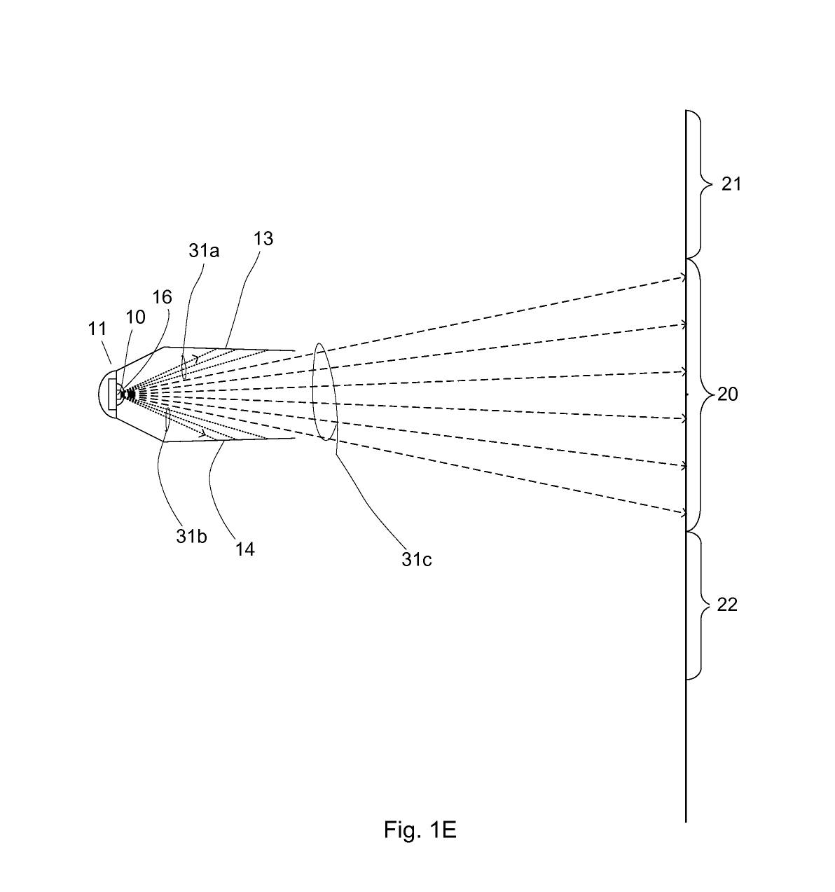

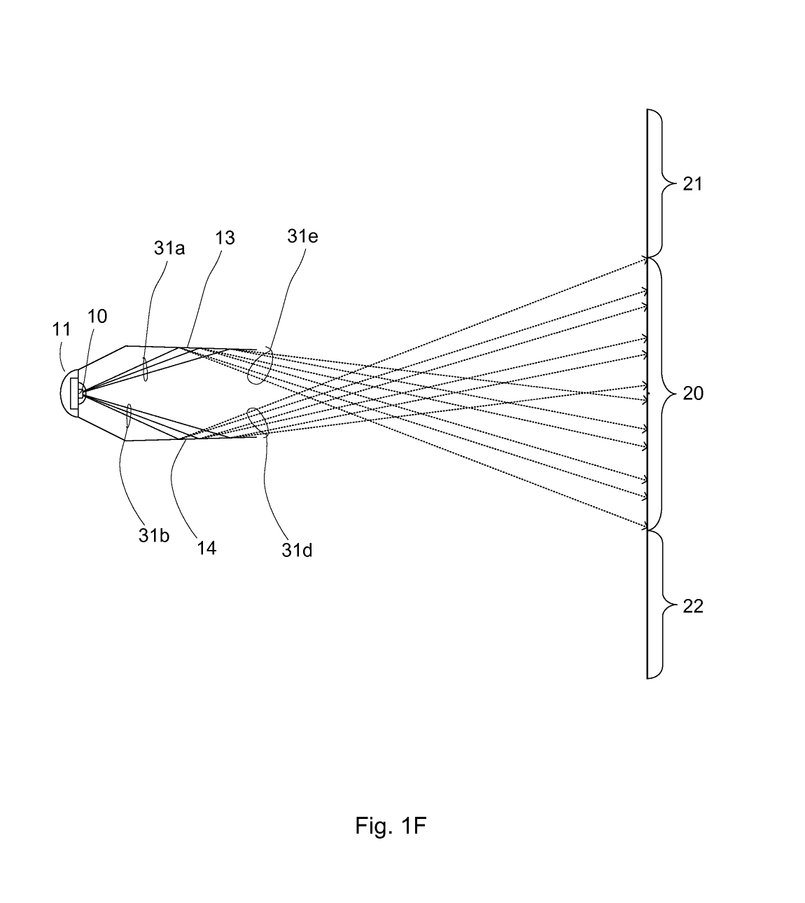

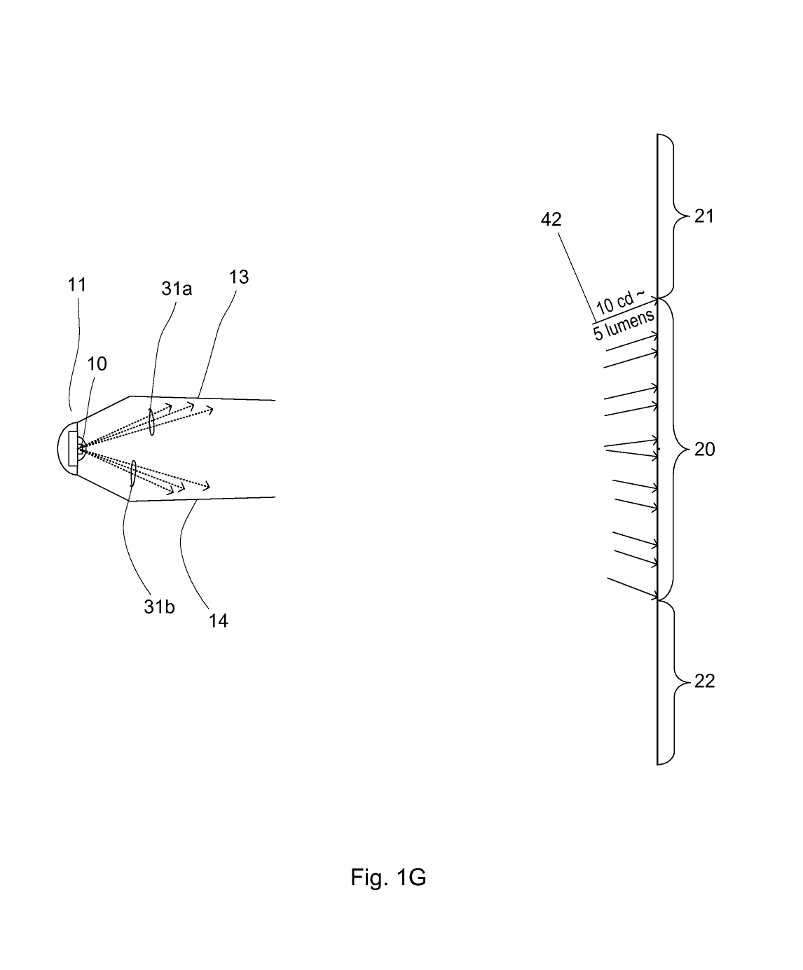

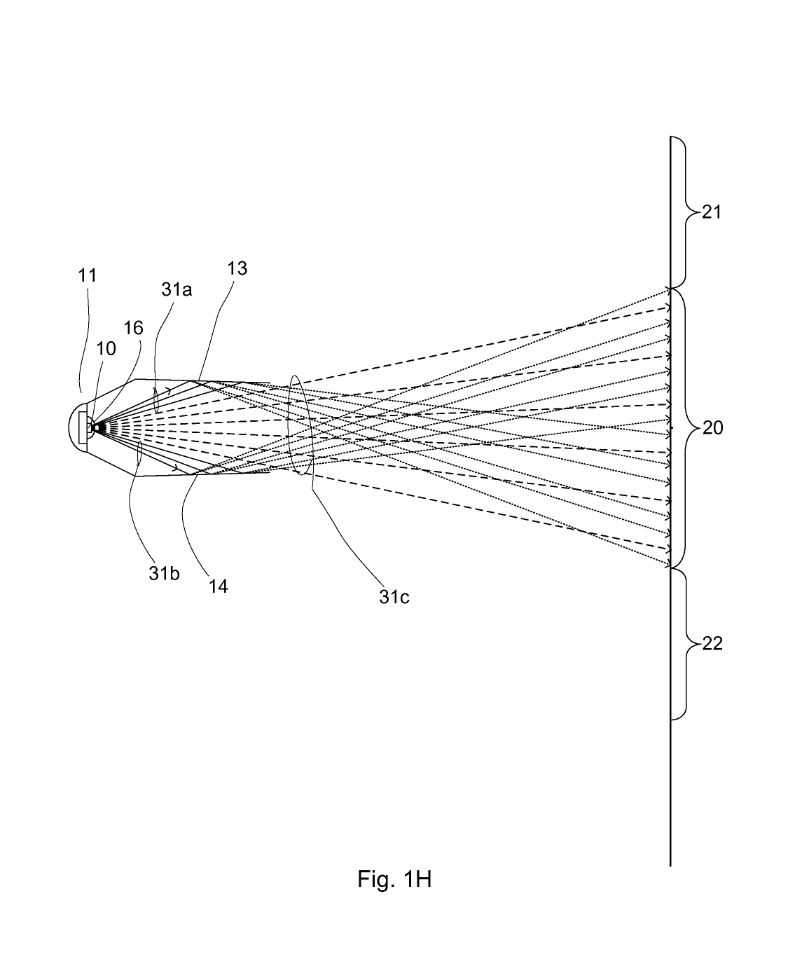

FIGS. 1A-1I illustrate various LED fixtures, target areas, and instances of illumination according to aspects of the invention as envisioned.

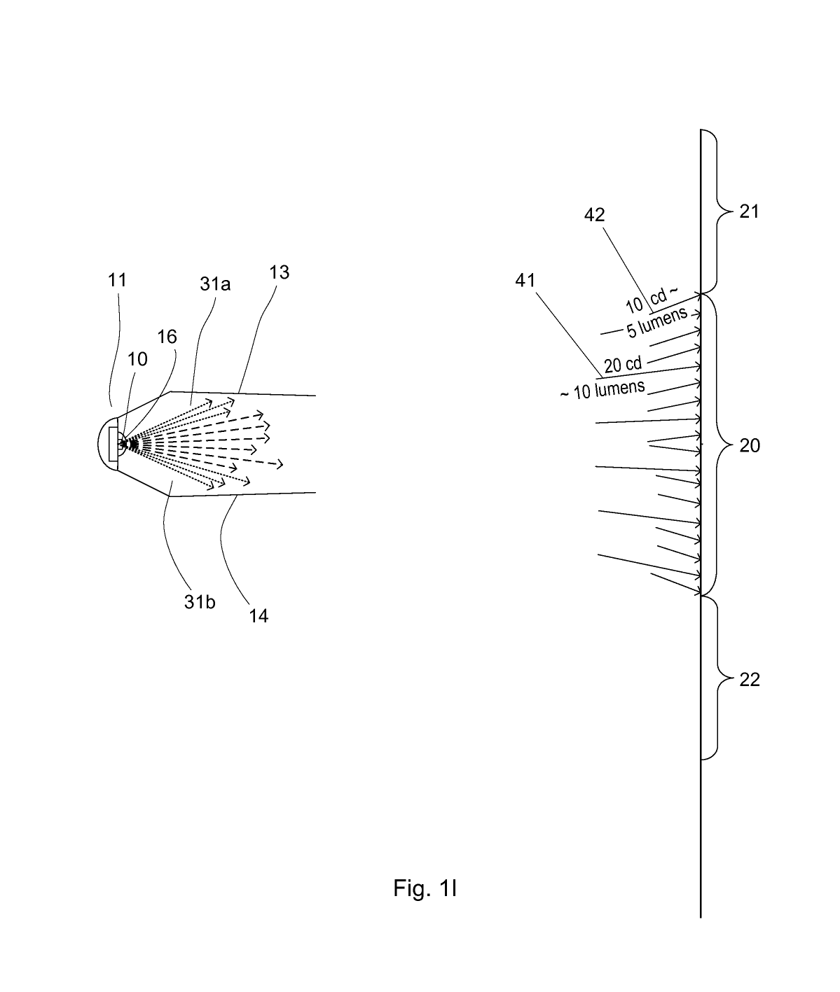

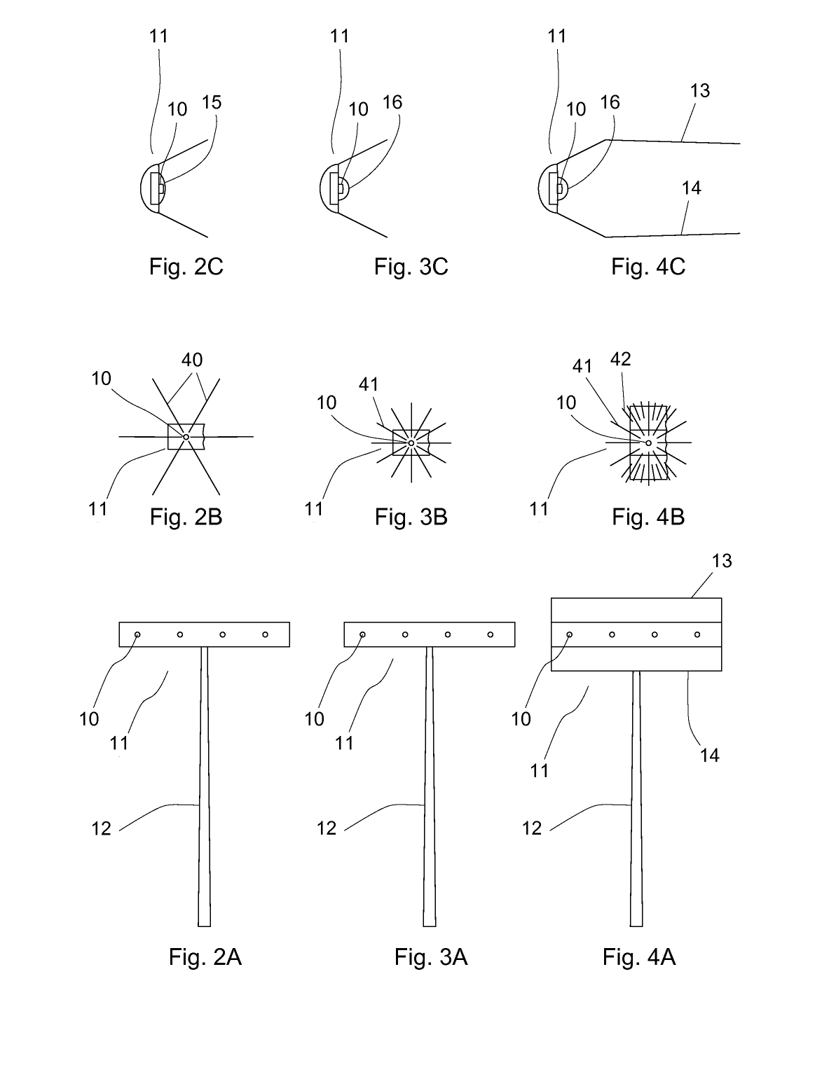

FIGS. 2A-C, 3A-C, and 4A-C illustrate views of various LED fixtures including some fixtures according to aspects of the invention as envisioned.

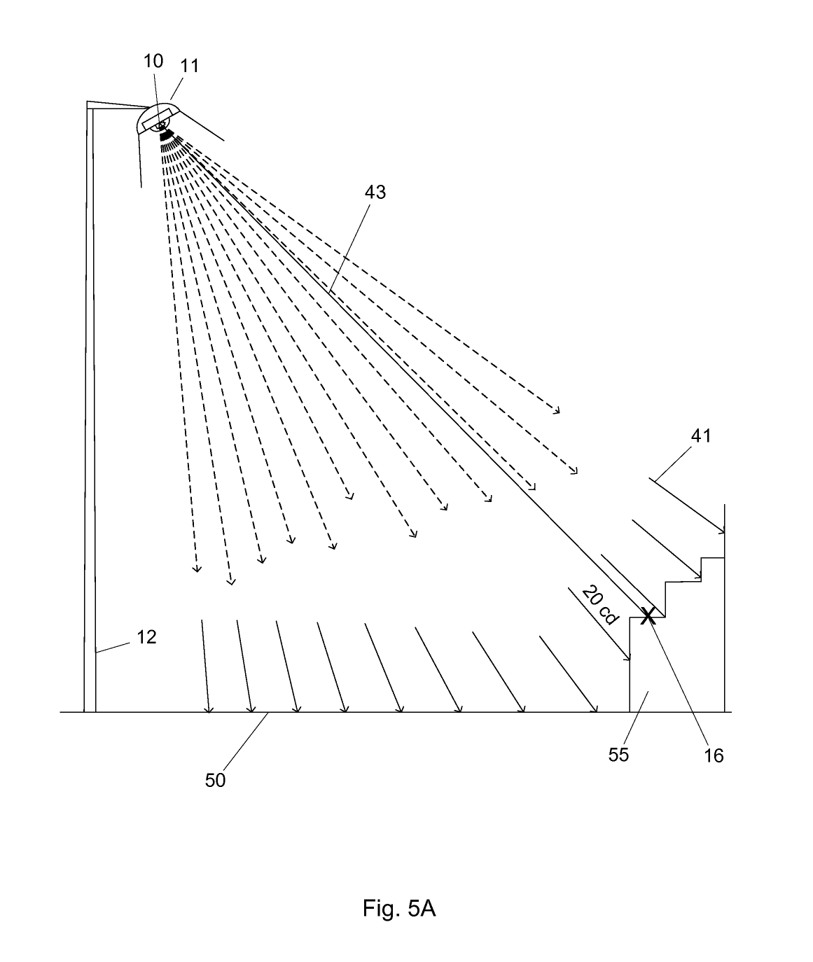

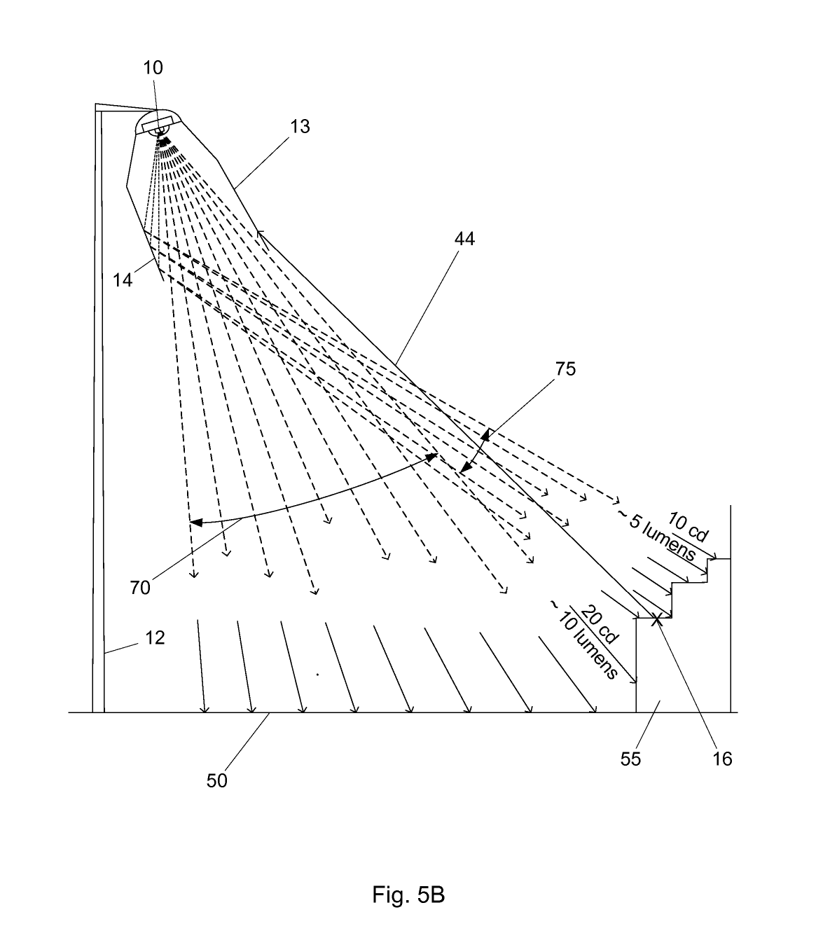

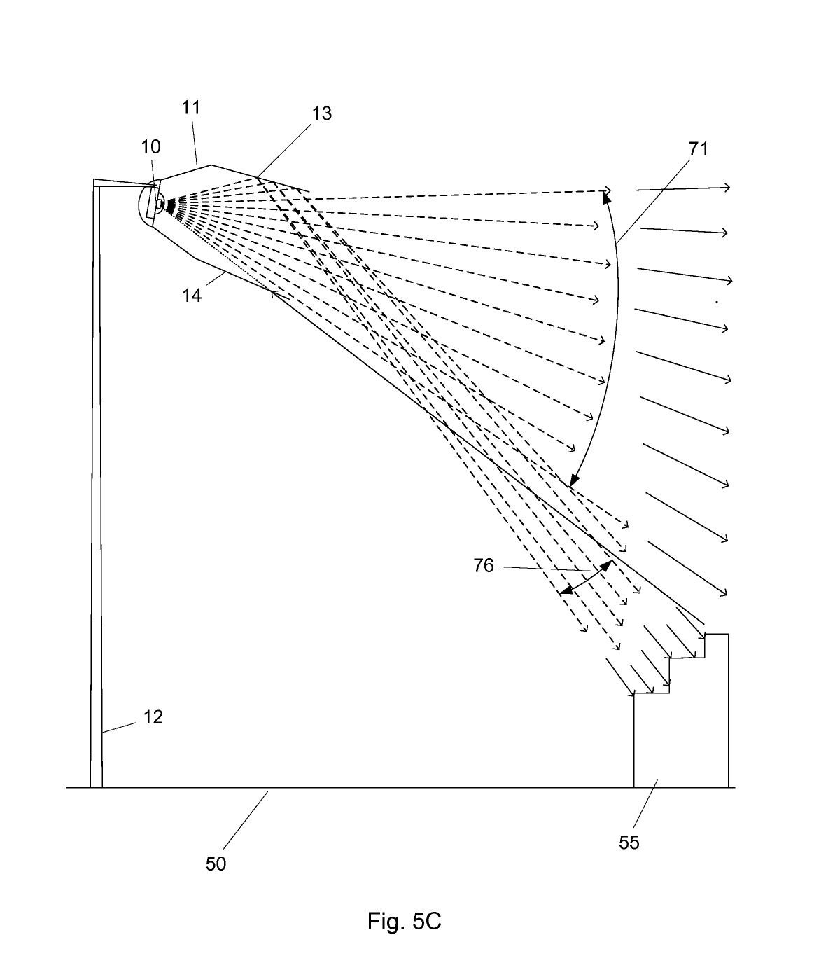

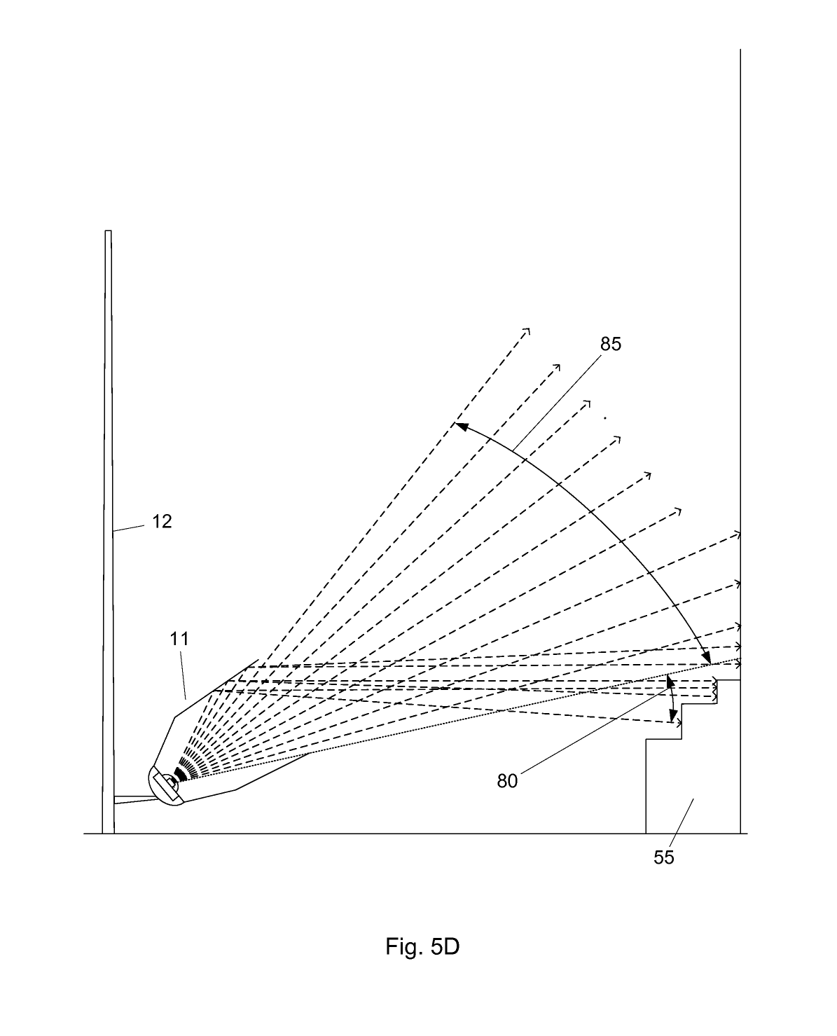

FIGS. 5A-D illustrate embodiments of LED fixtures according to aspects of the invention as envisioned.

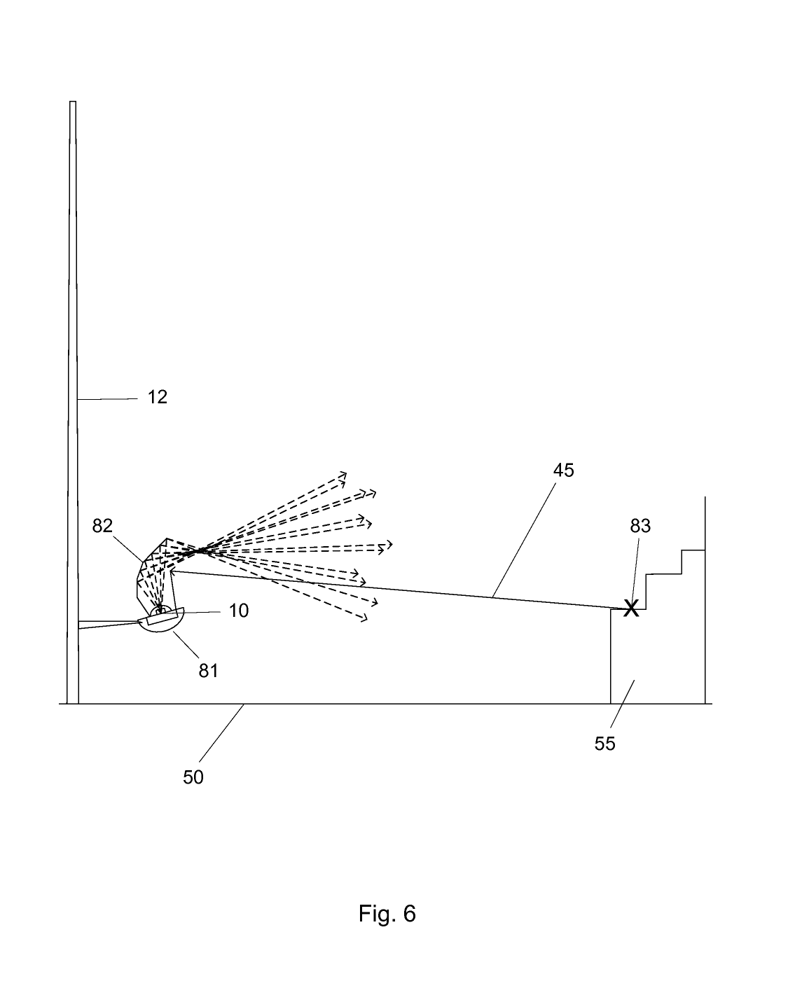

FIG. 6 illustrates an embodiment of an LED fixture according to aspects of the invention as envisioned.

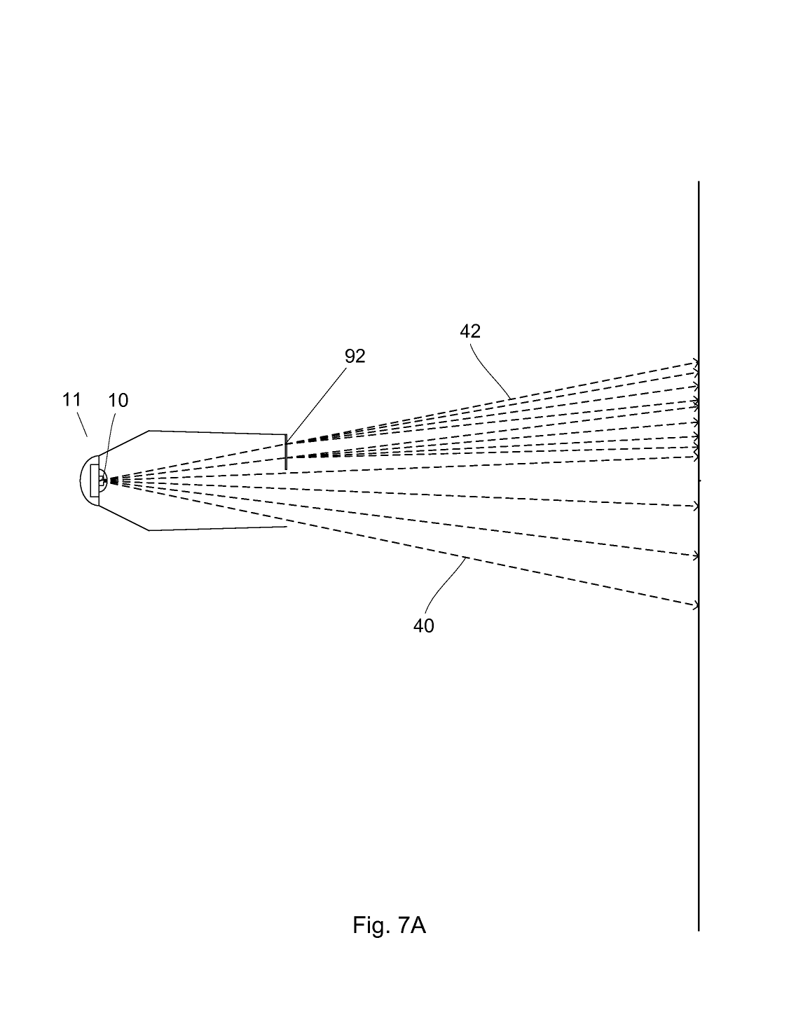

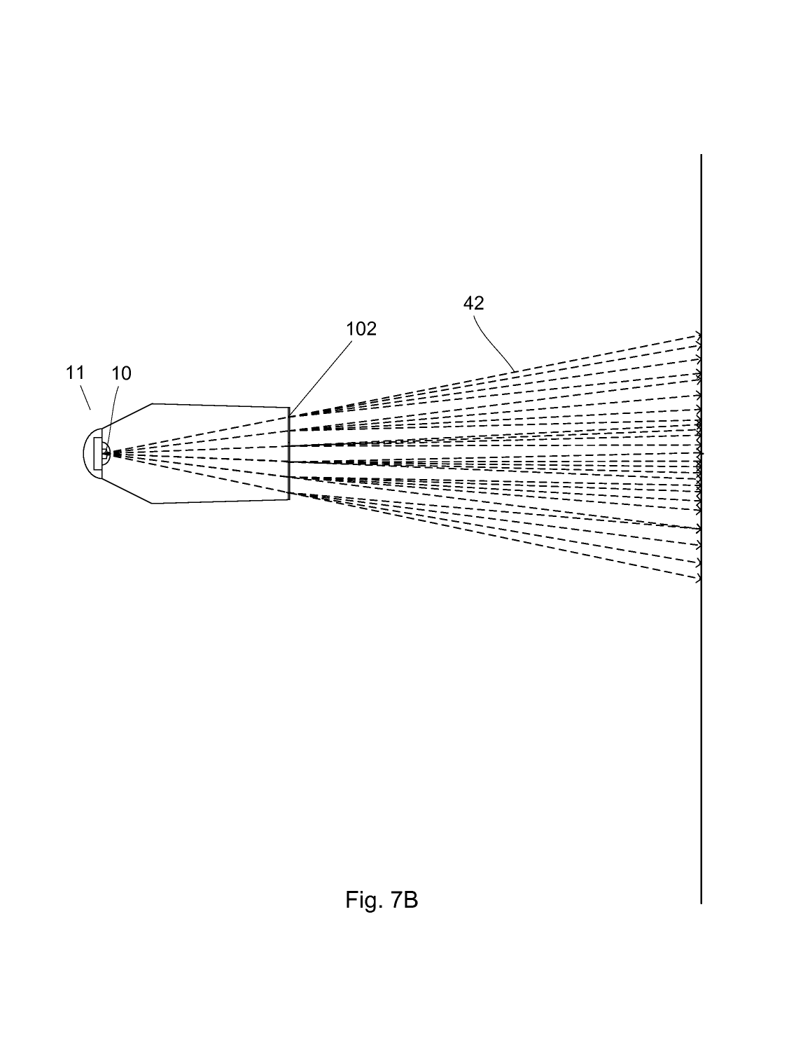

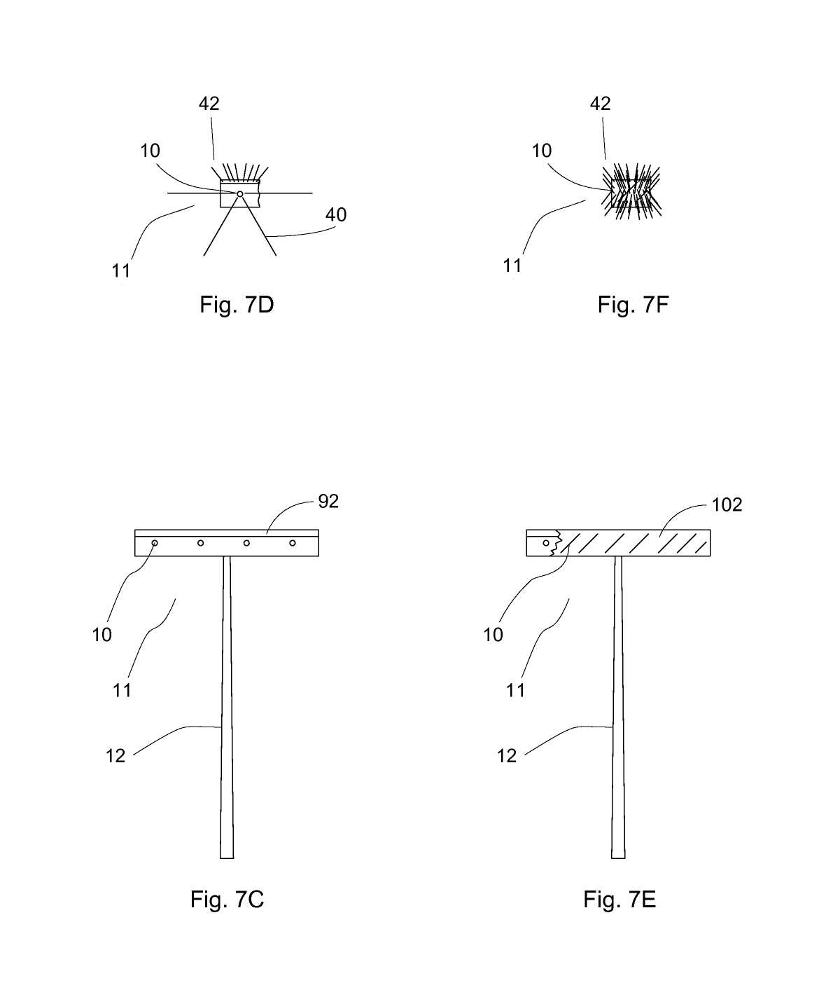

FIGS. 7A-F illustrate embodiments of LED fixtures according to aspects of the invention as envisioned.

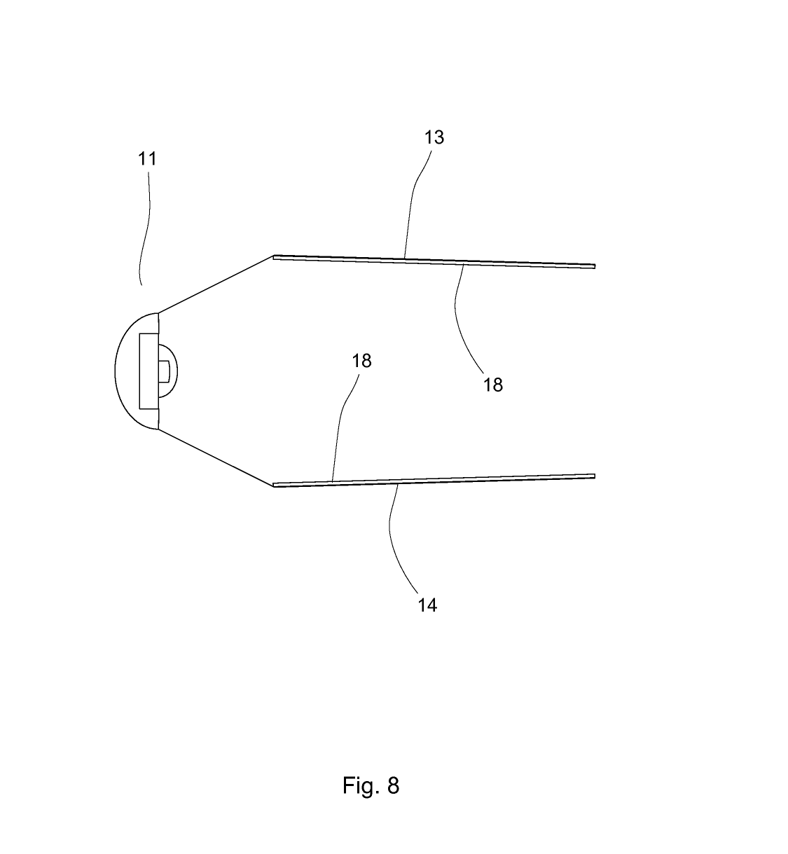

FIG. 8 illustrates a close-up view of an LED fixture according to aspects of the invention as envisioned.

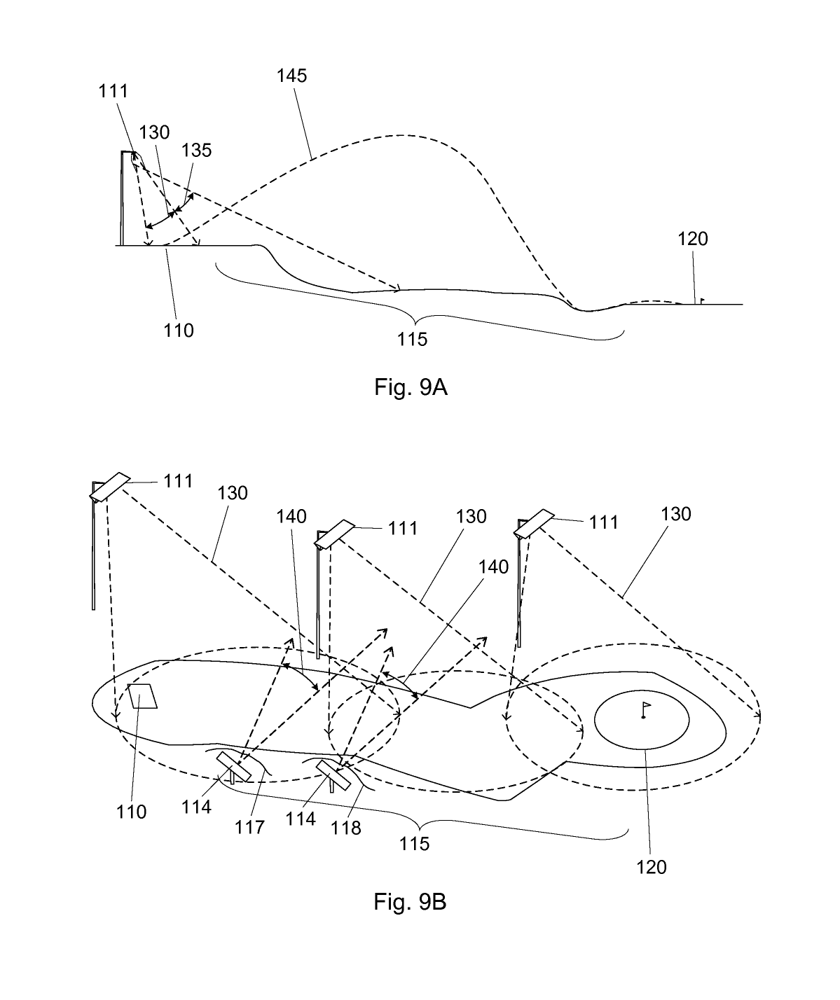

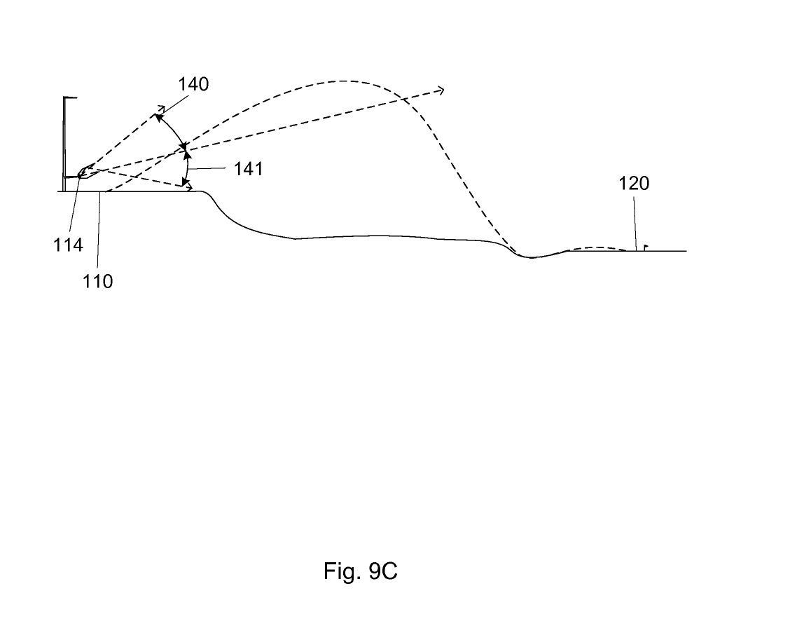

FIGS. 9A-C are diagrammatic views of a portion of a golf course with LED fixtures according to aspects of the invention as envisioned.

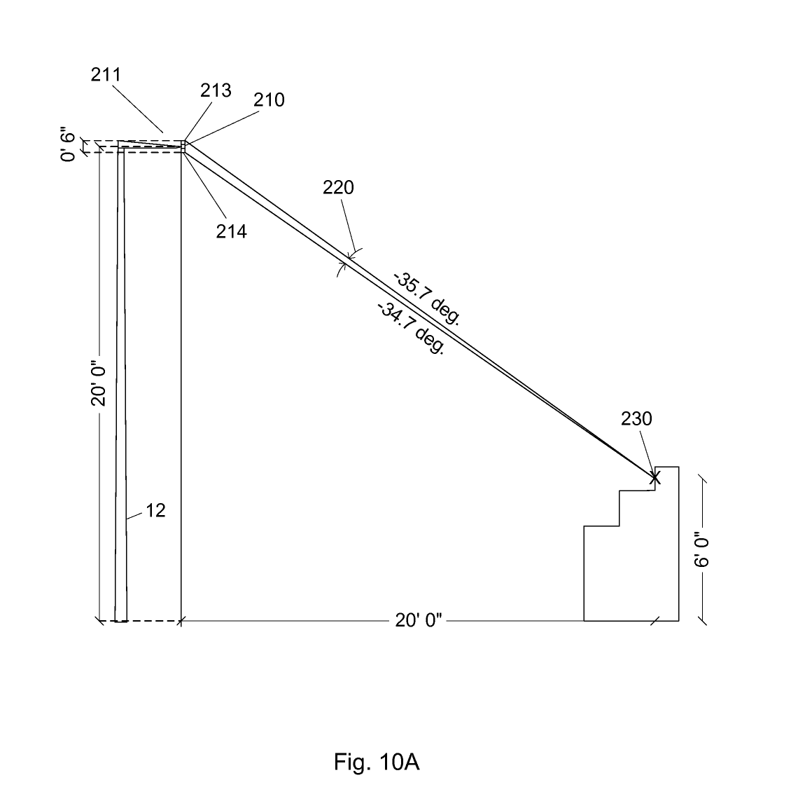

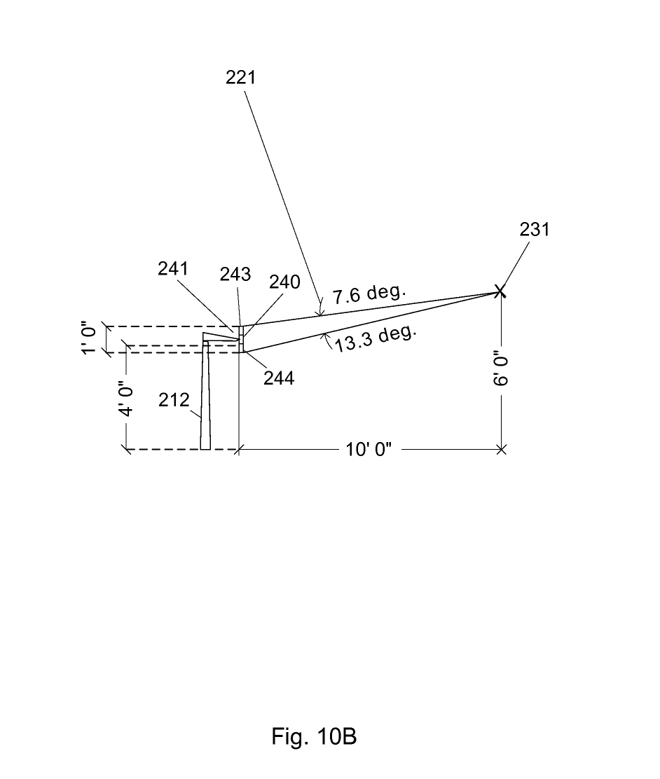

FIGS. 10A-B diagrammatically illustrate subtended viewing angles of fixtures according to aspects of the invention as envisioned.

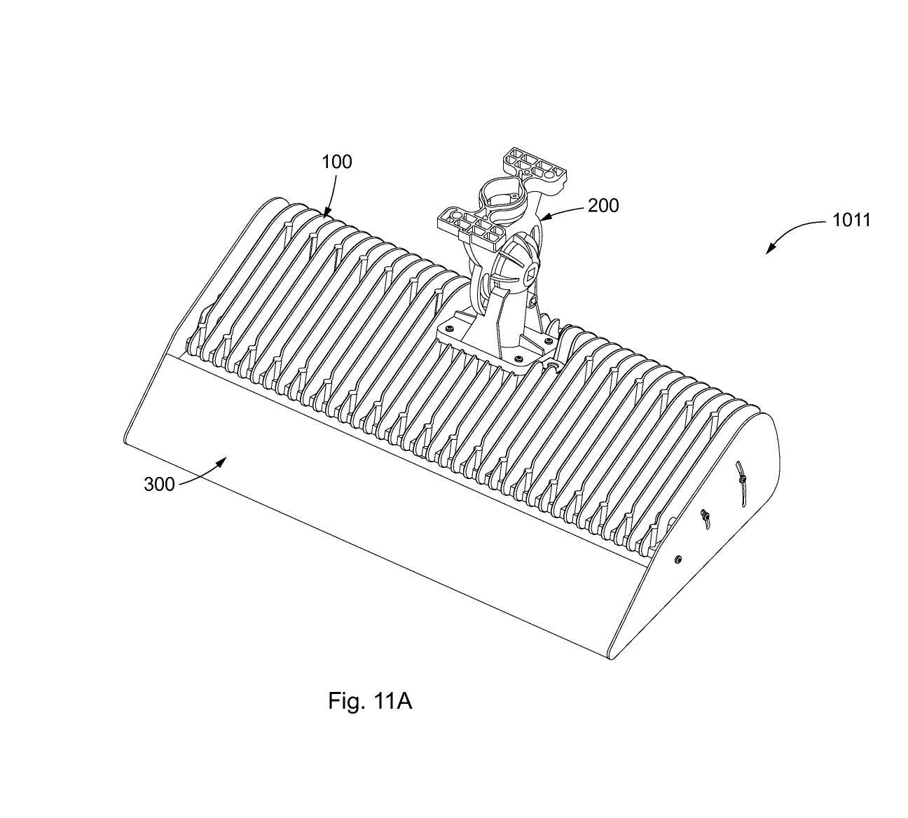

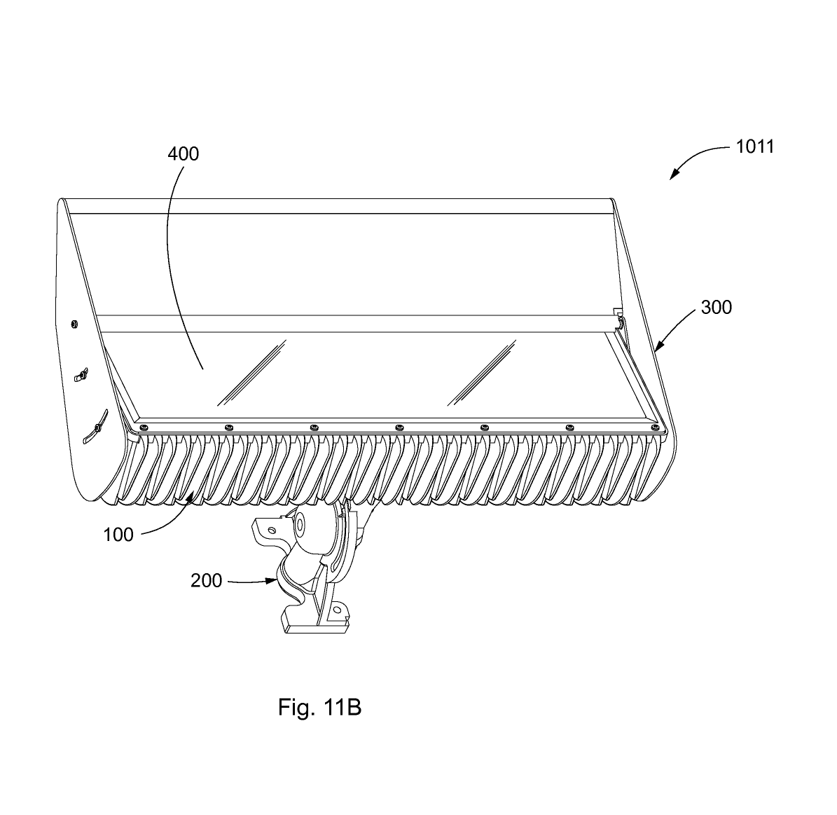

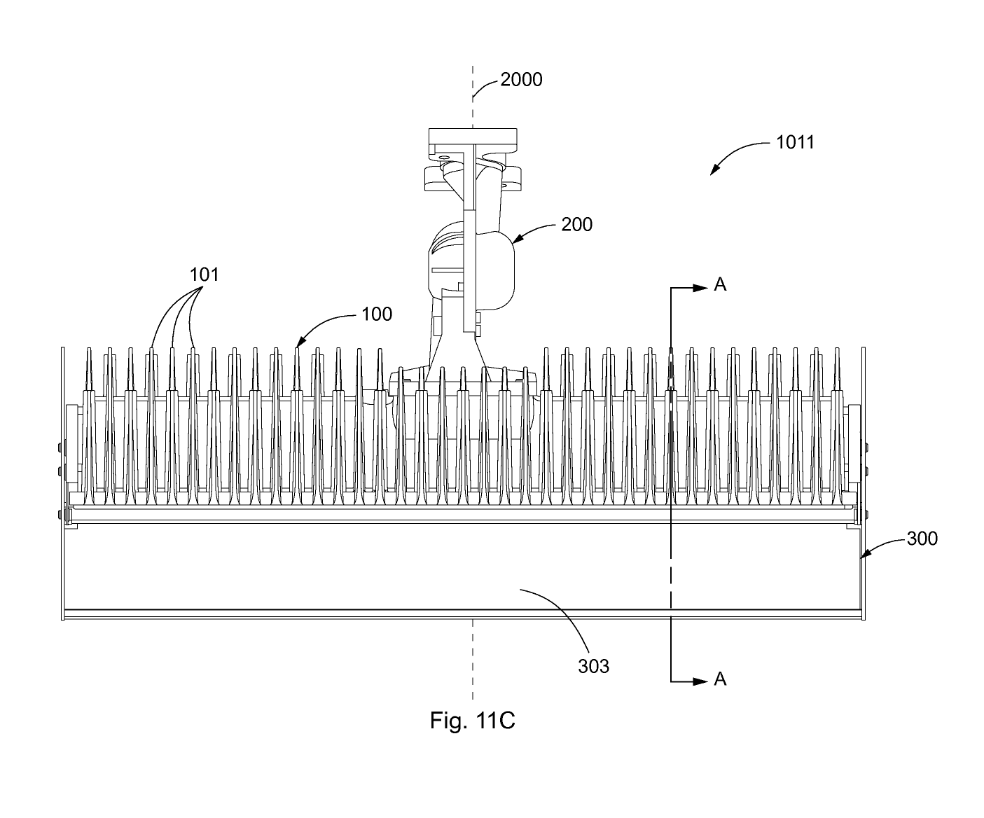

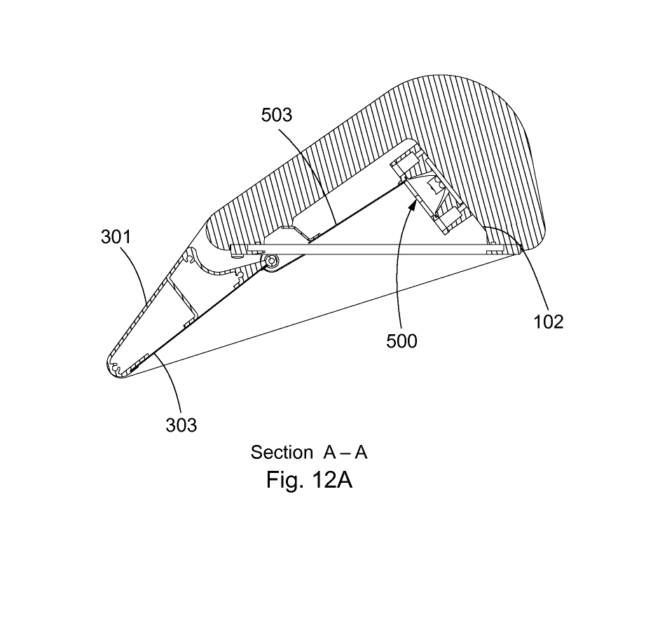

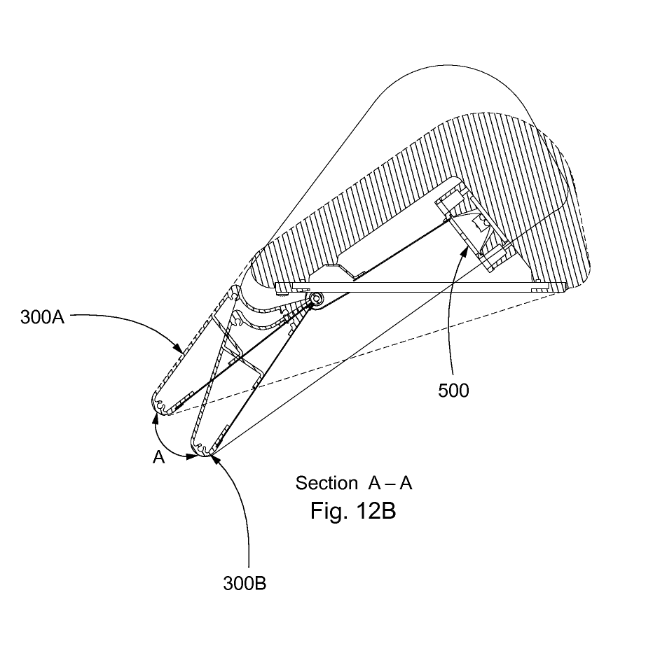

FIGS. 11A-C illustrate perspective views of a luminaire according to an embodiment of the present invention. FIG. 11C illustrates a back view of the luminaire.

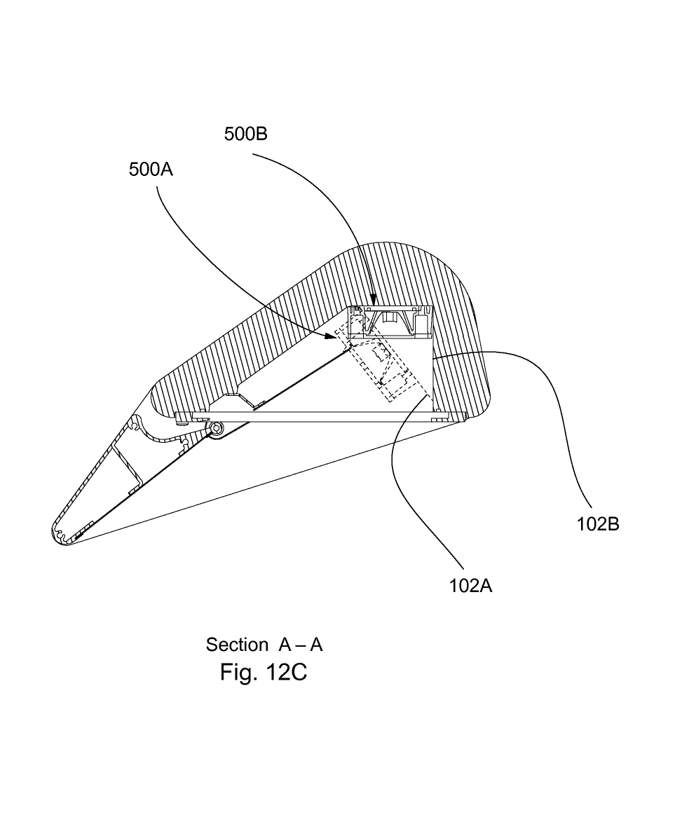

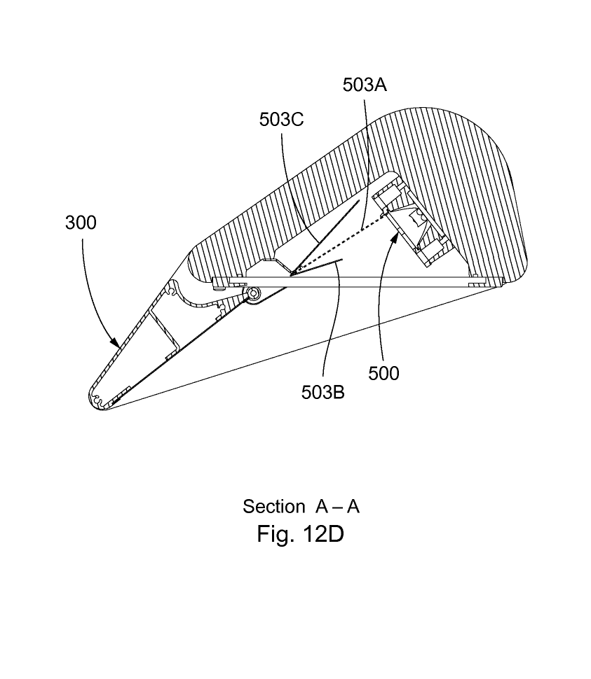

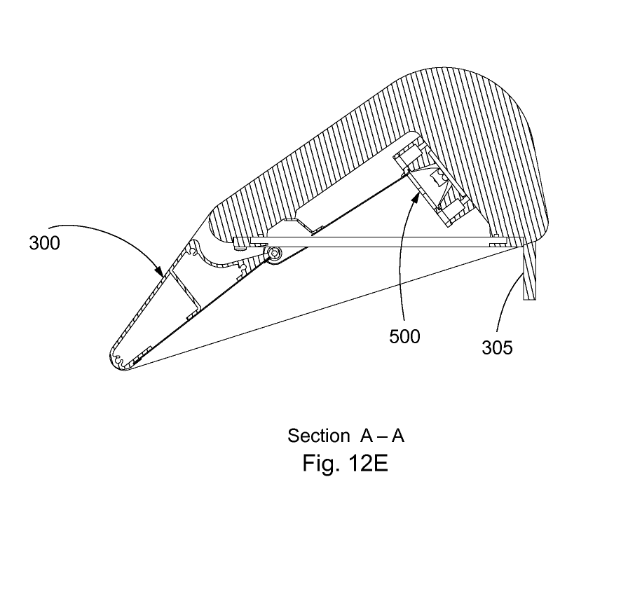

FIGS. 12A-E illustrate a section view of the luminaire of FIGS. 11A-C along line A-A of FIG. 11C. FIG. 12A illustrates the basic section view. FIG. 12B illustrates the section view of FIG. 12A showing different pivoting positions of visor 300 (see 300A and 300B). FIG. 12C illustrates the section view of FIG. 12A showing different mounting surfaces 102A and 102B. FIG. 12D illustrates the section view of FIG. 12A showing different aiming angles of interior visor 503 (see 503A-C). FIG. 12E illustrates the section view of FIG. 12A showing the addition of an optional reflective component 305.

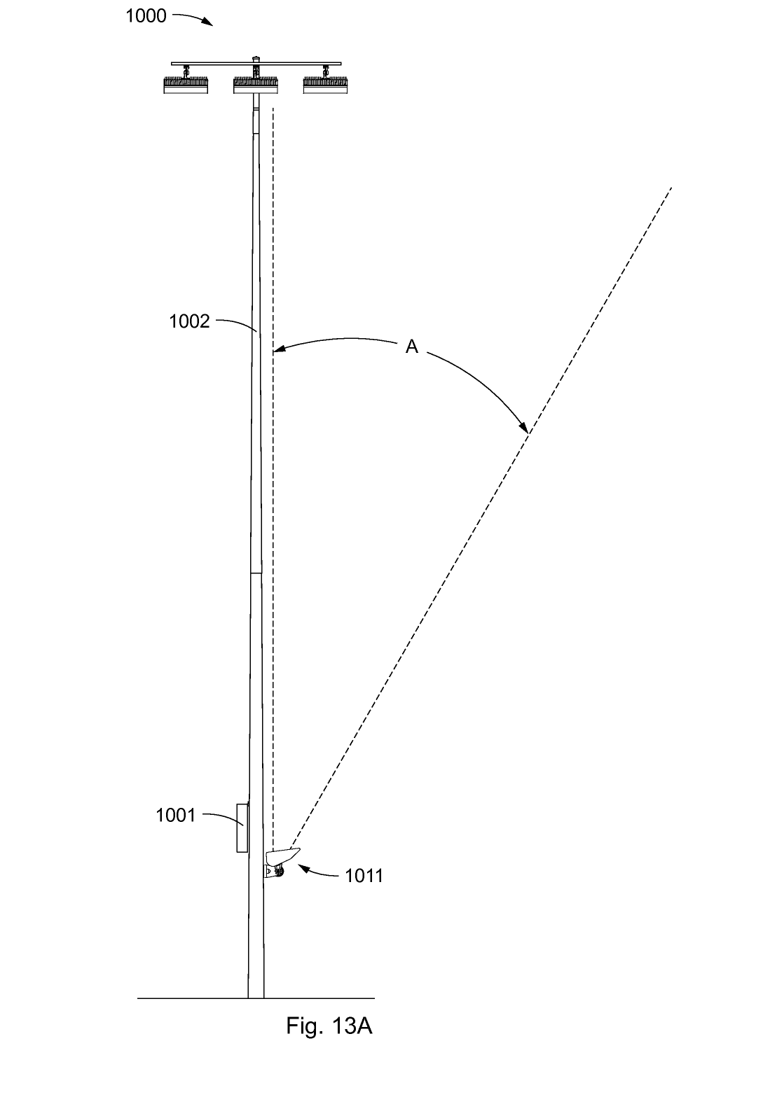

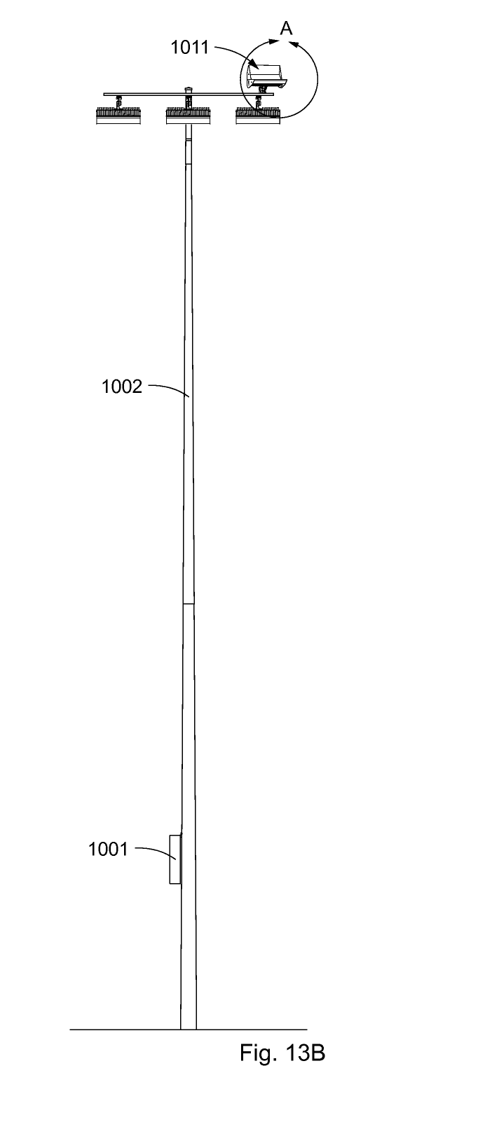

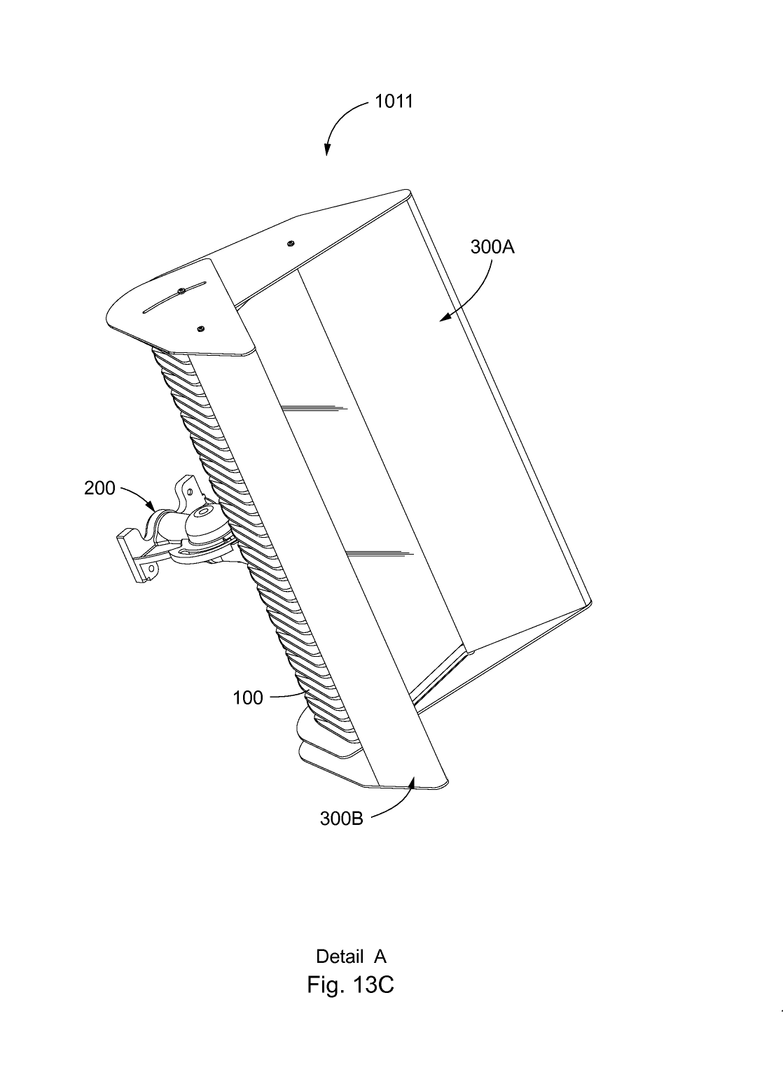

FIGS. 13A-C illustrate two possible options for uplighting using the luminaire of FIGS. 11A-C. FIG. 13A illustrates the fixture mounted low on a pole and inverted. FIGS. 13A and B illustrate the fixture mounted high on a pole within an array and with an additional external pivot visor 300 (see 300A and 300B). FIG. 13C is an enlarged view of detail A of FIG. 13B.

### DETAILED DESCRIPTION OF EXEMPLARY EMBODIMENTS

### Background

In general, if a lighting source is diffuse, it is not as hard to look at as a pinpoint (less diffuse) source. LEDs which are used for area lighting such as for sports lighting are generally considered to be relatively harsh sources of light since they are close to point sources of light (relative to many or most other large or wide area light sources). Therefore apparatuses and methods to diffuse LED lighting can be desirable. Hickcox, et al. (“Effect of different coloured luminous surrounds on LED discomfort glare perception” by Hickcox, K. et al, published in Lighting Research and Technology on Feb. 20, 2013, (lighting Res. Technol. 2012; 0:1-12) which is hereby incorporated by reference in its entirety), have demonstrated that surrounding LED lights with luminous sources which contribute some measurable fraction of the total light seen by a viewer can significantly reduce the perception of glare. Their experiment used a separate luminous source (“a half-cylindrical light box that acted as an integrating chamber”), which would be cumbersome to implement in the field. The system, method and apparatuses described herein are a way of providing similar benefits, and are therefore an improvement to the art.

While it is known that one way to diffuse LED light is to use translucent, prismatic, diffractive, or other lens material, another way to diffuse light from LED sources is to use reflective materials. Reflection can be partial so that there is a larger area from which light is emitted onto a target, or it can be total so the source is hidden. Even partial reflection while the source remains visible can be beneficial for the eye's adaptive effect since a larger area helps to trigger the eye's light adaptation and diminishes the effect of the pinpoint lights.

In general, uplighting solutions for lighting need to balance the need to avoid glare while providing lighting to the ‘fly zone’ of a sports field (e.g. the space above the field where balls or objects needed to be seen by users of the field can travel). This is particularly true with lighting systems where it may not be possible to have dedicated uplighting separate from the light which are primarily used to light the field Likewise, when LED lights are used, it is necessary to consider possible harshness that could cause discomfort or disabling glare in the eyes of a spectator (e.g. a viewer off the field or target area). Therefore uplighting solutions that can diminish harshness by either blocking LED sources from view, or by reducing the harshness effect by creating a light source that is effectively much larger than the LED by itself, can be beneficial.

Therefore using a reflector, visor, or surround (e.g. some surface or surfaces around at least a portion of the source) that not only cuts off light but redirects light to a more desired location and creates a luminous surface, either close to LED light sources or in place of LED light sources, actually has an effect that has not been previously appreciated in the lighting industry. This solution provides multiple effects which are previously unanticipated, in a combination which increases the effectiveness of the lighting by more than just the sum of the individual effects. These effects include increasing the area from which light projects, which cuts down on both actual intensity and perception of intensity, as well as redirecting light to the field thereby raising the level of light on the field, which reduces the actual brightness required from the light source.

### More General Embodiment

For purposes of a more general embodiment, it is necessary to discuss certain lighting conditions which use principles which are well-known in the art. LEDs put out a given amount of light energy in lumens based on their construction and operating conditions. This energy can be easily measured and calculated by those having skill in the art. However, a measurement of lumens emitted does not directly indicate the “intensity” of the light source, either in mathematical terms or as a perception of a viewer. Intensity is perceived of as “brightness.” This means that a single LED might emit a low number of lumens compared to other light sources (such as e.g. HID or high intensity discharge lamps), but might be perceived of as very intense or bright. Mathematically, intensity is a measure of light per given area, expressed in SI units as lumens per steradian (sr) or candela (cd). A given LED might emit 100 lumens, but its brightness could be relatively low if the light were evenly distributed over a hemispherical region. On the other hand, another LED might emit only 10 lumens, but if that light were concentrated to a tightly focused beam covering a solid angle of e.g. 2°, the second LED would be much more intense, and perceived of as much brighter, than the first LED.

Mathematically, since radiant intensity is measured in lumens/sr and there are 2π steradians in a hemisphere, the first LED discussed above (the 100 lumen output) would have an intensity of 100/2π or approximately 16 candela. The second (the 10 lumen output) LED is emitting light into a solid angle of 5°, or approximately 0.087 radians. This is converted to sr by the formula sr=2π (1−cos(θ/2)) where θ is the beam angle. Thus sr=2π (1−cos(0.087/2))=0.0059 sr.

Then 10 lumens divided by 0.0059 sr=approximately 1700 candela. The result is that the 2nd LED, which is emitting 1/10 the light energy of the first, is perceived of as 100 times brighter. In the examples below, the mathematics will be simplified, assuming arbitrary values for intensity in candela and light output in lumens; however the point is that proportionality is maintained according the principles of the art—so if the light from a single LED is distributed over twice the area, its intensity with be cut in half, etc. Likewise, for a given LED emitting light into a given beam angle, there will be an associated and proportional amount of energy arriving at the target. These values will be represented graphically by arrows representing both luminous intensity (cd) and an arbitrarily assigned but proportional luminous energy (lumens) value. So, in the examples below, a 40 cd luminous intensity will be considered to represent an (arbitrarily assigned) 20 lumens of energy on a given area; 20 cd will represent 10 lumens of energy on the same area, etc. Measurements of illuminance (lumens/m̂2=lux) would of course be relevant when designing embodiments, since design for lighting installations normally specifies required illuminance (typically quantified in lux). However in the embodiments below, areas and relative distances of light sources remain the same, and proportional to each other, so actual illuminance values would drop out of any equations. Therefore, while according to the principles of the art, illuminance (lux), intensity (cd) and lumens cannot be simply correlated since illuminance is a measure of light energy per area, intensity is a measure of light energy per solid angle, and lumens are a measure of total light energy from a source, in this case, since the areas are simply assumed and remain the same throughout the example, proportionality of candela to lumens for this example can be maintained. Further, the methods of diffusing the source outlined below effectively change the luminous source from a single LED to multiple sources, thus even though in some embodiments the entire energy of the LED is applied to the source the apparent intensity is effectively reduced, since from the point of view of the target there is more than one source. A person having ordinary skill in the art will be able to calculate actual light-source intensity and lumens striking at target area given actual LED, wattage, lens, reflectance, etc. specifications.

### First Condition

A more general embodiment of an LED light source 10, FIG. 1A, is shown in a first condition of operation with a first type of primary lens 15 (a lens right at the LED die). LED 10 is emitting 120 lumens of light energy (diagrammatically illustrated in FIG. 1A by way of simplified light rays 30) which strike a target area 20. The intensity of the light is represented by six arrows 40, FIG. 1B, where each arrow represents 20 lumens, emitted at an intensity of 40 cd over equal portions of target area 20. The observer's view of this fixture is represented by FIG. 2A-C.

FIGS. 2A, 3A, and 4A show various configurations of fixture 11, as described below, comprising one or more LED light sources 10, mounted on pole 12, shown as they would illuminate a target area 20, FIG. 1B. For simplicity, only one LED in the fixture will be discussed or shown operating.

FIG. 2B represents a partial view of fixture 11 as described in the first condition of operation above, showing six lines 40 emanating from LED 10 that correspond to the six rays 40, FIG. 1B. FIG. 2C shows a side view of fixture 11. As previously noted, an observer within the target area 20 looking at this light, represented by FIG. 2B, might find the intensity of the light, at 40 cd, from the point source 10 objectionable or painful.

### Second Condition

A second condition is a response to condition one (described above), in an attempt to reduce the harshness of the lighting of condition one. In this second condition, in order to reduce the intensity of the light in the eye of the observer, a different primary lens 16, FIG. 1C (i.e. different than illustrated in FIG. 1A), is selected to distribute the 120 lumen output by way of simplified light rays 31 which are distributed over a wider area, and which strike a wider target area (see FIG. 1C). The intensity of the light is represented by 12 arrows 41, FIG. 1D, where each arrow represents 10 lumens at an intensity of 20 cd of light energy distributed over target areas 20, 21, and 22, which together are on the order of twice the size of the original target area 20. Six of the arrows 41 strike the original target area 20, and three of the rays 41 strike the each of the additional areas 21 and 22. This reduces the intensity of the light experienced by the observer, which is better for the observer, but reduces the light on the desired target area 20 by 50% to 60 lumens. This might be unacceptably low for players on a sports field, and might at the same time be unacceptably high on areas 21 and 22 if they are not desired target areas.

The observer's view of the fixture of FIGS. 1C and 1D is represented by FIG. 3B, where the 12 smaller lines 41 emanating from the LED 10 correspond to the 12 arrows 41, FIG. 1D. FIG. 3A represents the modified fixture of the second condition above which to the distant observer would be essentially indistinguishable from the fixture of the first condition above shown in FIG. 2A. FIG. 3B represents a partial view of fixture 11, showing 12 lines 41 emanating from LED 10 that correspond to the 12 arrows 41, FIG. 1D. FIG. 3C shows a side view of fixture 11. An observer within the target area 20, looking at this light, represented by FIG. 3B, might find the intensity of the light from the point source 10 to be acceptable as to its perceived intensity at 20 cd, but potentially too dim with regard to the amount of light available for watching activities within the area. Likewise, observers within target areas 21 or 22, under some circumstances might still find this same 20 cd level of illumination objectionable, particularly if areas 21 or 22 are outside of the desired area of illumination. Thus there may be need for further improvement.

### Third Condition

In a third condition, visors 13 and 14, FIG. 1E are installed on the light fixture 11 with the same lens 16 from condition two, FIG. 1C. This is useful to prevent light spilling onto areas 21 and 22. However, when light intensity has been reduced per the second condition, there is still insufficient light in the desired target area 20, since the light represented by rays 31a and 31b is blocked.

### Fourth Condition

In a fourth condition, in accordance with aspects of the invention as envisioned, reflective material 18, FIG. 8, is applied to the interior of the visors 13 and 14. This material tends to diffuse the light either by virtue of its surface finish, by the angle of incidence of the light striking it, or by other factors that would be known to persons having skill in the art. The visors therefore reflect the light represented by the upper and lower rays of light 31a and 31b, FIG. 1F. (The inner rays are not shown for clarity.) And because the light is diffused by the visor surface 18, the intensity of the reflected light is reduced considerably, without significantly reducing the amount of light energy reflected; this is represented by each light ray 31a and 31b splitting into multiple rays 31d and 31e, FIG. 1F. In this representative case the reflected light intensity is reduced by 50%, even though the amount of light striking area 20 from the reflected light is virtually the same as would be striking areas 21 and 22 without visors in place. This is shown in FIG. 1G where the arrows 42 resulting from the reflection of light rays 31a and 31b each represent a 10 cd intensity. The result is that 60 lumens of energy has been restored to the target area 20, but because the light source is now diffuse, the observed intensity is greatly reduced. FIG. 1H shows the addition of the inner rays to the drawing from FIG. 1F, so that the outer rays 31a and 31b, and the inner rays 31c are all shown. FIG. 1I represents the remaining arrows 41 as originally represented in FIG. 1D along with the arrows 42 from FIG. 1G. This illustrates the fact that while the intensity of light in target area 20 nowhere exceeds 20 cd, the full 120 lumens has been restored to target area 20. This removes the spilled light from areas 21 and 22 and prevents the light striking target area 20 from being perceived as too intense. Visor 300 of FIG. 11A-C, also shown in FIG. 12A-B and 13A-C, illustrates another embodiment of visor 13 or 14, FIG. 1E. Visor 300 of FIG. 2A-C U.S. Published Application U.S. 2013/0250566 A1 (formerly U.S. application Ser. No. 13/897,979) (incorporated by reference herein in its entirety), also shown in FIG. 4A-E and 8A-C of U.S. 2013/0250566 A1, illustrates another embodiment of visor 13 or 14, FIG. 1E. Note that size and construction of the visors will be determined by several factors, including site considerations and mounting locations. In general, the larger the area over which the light can be diffused, the more pronounced the improvements will be. This would favor making visors quite large relative the LED sources. However, for luminaires mounted high in the air on poles, the effective projected area (EPA) against wind forces is significant factor in forces applied against the poles. A large EPA adds much more force against the supporting structure, and the benefits of increased effectiveness of a large visor must be weighed against the need to create stronger support structures on account of greater wind loads. So for luminaires mounted very close to ground level, it would likely be more beneficial to make the visors or diffusors quite large, where for poles mounted high in the air, the visors will likely need to be smaller to avoid adding too much to the cost of installation. Likewise, for golf course where players might be required to play quite close to lighting on the ground as illustrated by e.g. luminaires 114, FIG. 9B, it might be advantageous to make the visors or diffusing elements very large in order to reduce glare as much as possible. Further experimentation will likely yield more precise suggestions for optimum surround size, however the cited study from Hickox suggests that providing a luminous surround area that subtends an angle at least as large as the LED source would be considered a lower limit for utility in reducing perceived glare. Doubling that so that the luminous surround area subtends an angle twice that of the LED source is likely to be considered a maximum for high-mounted light sources subject to wind loading considerations.

FIG. 4A represents the fixture with added visors. The observer's view of the fixture in operation is represented by FIG. 4B, where the 6 small rays 41 and 12 even smaller rays 42 emanating from the LED 10 correspond to the 6 rays of light 41 and the 12 rays of light 42, FIG. 4B. FIG. 4C represents a side view of fixture 11 with added visors 13 and 14.

Note that in the four postulated cases or conditions above, the total amount of light from the LED is the same. In the first case, the target area is sufficiently illuminated, but the light intensity may be objectionable to the observer. In the second case, the light intensity is acceptable to the observer, but the target area illumination may be insufficient for sports play and spills into areas that might not be desired targets. In the third case, light intensity is acceptable to the observer and is no longer spilling into the area where it is unwanted (i.e. spill light has been removed) but light intensity may not be sufficient for play, and half of the light output (i.e. the light which is blocked by visors 13 and 14, FIG. 1E) may be wasted. In the fourth case, light intensity may not be objectionable to the observer, since the source is much larger, spill light has been eliminated, and the amount of light may be sufficient for sports play since the entire 120 lumens is directed to the target area.

### Sports-Specific Additional Embodiment

The generic fixture above is described in an application where the lighting is generally targeted at an angle such that an observer can see the individual LED light sources, as in FIG. 4A (an ordinary viewer of fixture 1I would have direct line-of-sight of each LED 10). However a common application for sports lighting targets a high level of illumination on a sports field such as a golf course, football field or soccer pitch, but does not intend for much, if any, light to be targeted from the fixtures lighting the field onto the sidelines or spectator area (and thus tends to limit direct view of the light sources by spectators off the field). Therefore a beneficial effect of a reflective visor or surround may be much more pronounced in improving the effect of installed lighting by preventing illumination that strikes sideline observers, while not interfering with light directed to the field. FIG. 5A shows a simplified diagrammatic view of a typical sports field light installation. A fixture 11, mounted on pole 12 is directed to field 50. Since many fixtures do not control light well, when such a fixture is aimed to provide sufficient illumination on the field, some light from the fixture spills onto the spectator area 55. This often results in unpleasant glare in the eyes of the spectators, which is shown by the three arrows 41 above line 43, each representing 20 cd light intensity. However, when a lighting fixture according to the generic embodiment described above is used, this unpleasant glare may be reduced or eliminated. Previous FIG. 3B shows the view that an observer might have of a single LED light source that does not use the described reflective visors. However, because the fixture is aimed more generally at the sports field, the addition of upper visor 13 and lower visor 14, FIGS. 4A and C, may result in effectively blocking the view of the unshielded LED light. FIG. 5A illustrates the first situation, where the spectator at location 16 is able to see the LED 10 directly, as shown by line-of-sight arrow 43 from point 16 to LED 10. FIG. 5B illustrates the situation where the fixture 11 is rotated down and the LED 10 is blocked from view by upper visor 13, as shown by line-of-sight arrow 44 from point 16 to visor 13.

FIGS. 11A-C, 12A-E, and 13A-C illustrate a fixture 1011 with visors installed according to aspects of the invention. U.S. 2013/0250566 A1 (formerly U.S. patent application Ser. No. 13/897,979), which is owned by the current applicant and which is hereby incorporated by reference in its entirety, illustrates a fixture with visors installed according to aspects of the invention.

### Uplighting Additional Embodiment

An important aspect of embodiments of the invention as envisioned is the ability to enhance light to the area above a playing field. U.S. patent application Ser. No. 12/939,838, incorporated by reference herein, describes the need for uplight in sports lighting. This embodiment provides an innovative means of allowing some uplighting, without causing excessive light intensity in the eyes of spectators. The light that may be needed in the ‘fly zone’ (which impinges on spectator area 55, FIG. 5A) is diffused off the lower visor 14, FIG. 5B, with the result that the area (three dimensional space) described by arc 70, FIG. 5B, is illuminated directly by LED 10, but the area (space) described by arc 75, FIG. 5B, is illuminated by the diffused light reflected from the lower visor 14. Thus the observer in the spectator section would see or perceive a diffuse light source 14, where LED 10 was effectively hidden, while the playing field would be lit both by light from the upper visor 13 and the LED 10. This would substantially reduce the discomfort caused by the intensity of the LED light source while providing some desired light off the field.

Note that for all of the embodiments as shown, a single pole 12 and a single spectator area 55 is shown, however the embodiment described would be applicable to common installations having spectator areas surrounding the field and having multiple poles and fixtures. FIG. 5C illustrates another similar arrangement where fixture 11 is oriented more horizontally and some illumination is directed to spectator area 55, while providing more intense light on the fly zone (space) described by arc 71 and less intense light on the zone (space) described by arc 76.

In another optional configuration, FIG. 5D, fixture 11 may also be mounted on a pole 12 generally oriented up (and optionally lower on pole 12), as shown in FIG. 5D, in order to provide illumination up into the fly zone, where the area (space) described by arc 80 is illuminated by indirect light off of a reflective visor and area described by arc 85 is illuminated directly by LED 10.

Benefits of this embodiment can include blocking LEDs from some direct view to spectators, providing additional light to some parts of target area, providing diffuse light to part of target area, etc.

Other optional embodiments would use only upper visor 13, or lower visor 14 to provide at least some of the benefits previously described.

It should be noted that the reflectance percentages above are theoretical; actual reflectance of light energy will be less than 100%, but using commercially available materials can reflect a very high percentage of total light.

### Embodiment—Single Reflector, Visor, or Surround with LEDs Hidden or Partially Hidden

Another embodiment comprises one or more LED light sources 10 mounted in a fixture 81, FIG. 6. Reflector 82 redirects and diffuses light from LED light sources to the target area 55 or space. The LED light sources are partly or completely hidden from most or all viewing angles such as point 83, FIG. 6, as shown by line-of-sight arrow 45. This reduces or eliminates the possibility of an observer experiencing harsh light, glare, etc. from an LED light source, which makes this type of light attractive for locations requiring a very high degree of light control. The visor or reflector could be straight or curved in, for example, a cylindrical, parabolic, paraboloid, or free form curve, according to the needs of the installation. Visor 82, as with other embodiments, is shown diagrammatically for simplicity; the shape and size are shown basically as they would appear in a vertical plane. Such a shape could extend in and out of the page of the figures (if the illustration was an edge view). But they could also be curved surfaces rotated about a reference point and be more of a hood.

FIG. 11A-C illustrate a fixture with a visor 300, similar to reflector 82 of FIG. 6. FIG. 2A-C of U.S. 2013/0250556 A1 (U.S. patent application Ser. No. 13/897,979) illustrate a fixture with a visor 300, similar to reflector 82 of FIG. 6 of the present application.

### Embodiment—Diffusing Lens

FIG. 7A-F shows a representation of optional embodiments with partial or fully diffusing lenses. These embodiments comprises using a diffusing lens 92, FIG. 7A, intercepting and diffusing light from an LED light source 10 mounted in fixture 11. In this figure, rays 40 represent the non-diffused output of LED 10 and rays 42 represent the diffused output of LED 10. See also FIG. 7C. This can provide a light source similar to those previously described having some light output, directly from the LED light source 10 and some output, that is diffused. This embodiment can be used where it is acceptable to have some direct light but where some diffused light is desired. A view of this fixture is shown in FIG. 7C. A magnified diagrammatic representation of the observer's view of this fixture is shown in FIG. 7D where rays 40 represent the non-diffused output of LED 10 and rays 42 represent the diffused output of LED 10.

FIG. 7B shows the diffusing lens 102 intercepting most or all of the LED light so that the LED light source 10 is completely hidden from view. This would provide a very high level of reduction of glare and harshness. In this figure, rays 42 represent the diffused output of LED 10. A view of this fixture is shown in FIG. 7E. A magnified diagrammatic representation of the observer's view of this fixture is shown in FIG. 7F where rays 42 represent the diffused output of LED 10. This type of fixture might be particularly desirable to allow placement of lighting fixtures in previously unworkable locations, such as directly behind 2nd base at the edge of a baseball diamond. This location is normally avoided, since most lights cause too much glare in a batter's eyes.

### Embodiments—Sports Fields, Golf Courses

Embodiments as described could be used, among many locations, in sports fields where a ball is in aerial play, such as football, soccer, baseball fields, tennis courts, etc. The fixtures could provide downlight, with some uplight, or could be used to provide uplight, with some downlight. Other applications, both sports and nonsports, are possible.

### Application to Golf Course Use

Embodiments as described could be used for golf course illumination. FIG. 9A and 9C represent an elevation of one hole of an exemplary golf course. FIG. 9B shows a perspective of the same hole. In this example, terrain is shown as sloping toward the green, however golf courses typically follow the existing lay of the land, with the result that lighting needs can be quite varied. Therefore, golf courses need both downlight and uplight, with careful attention to avoiding glare and providing sufficient light to follow a fast-moving golf ball in the air and to follow it to the ground.

Golf courses need illumination at the tee location 110, the fairway and rough 115, and the green 120. Downlighting is provided by an embodiment which provides direct light in area (space) 130 and diffused light in beam portion (space) 135, FIG. 9A. This lighting typically will not fully illuminate the trajectory 145 from tee 110 towards green 120 of the ball as struck, since to do so could create excessive glare for viewers looking back at the tee location or from other locations on the course. Therefore it is beneficial to provide uplight 140, FIG. 9C, from additional fixture(s) 114, which provides illumination to the ball as it travels high through the air (see FIG. 9B). At the same time it might be beneficial to provide some horizontal light 141 from fixture 114 (FIG. 9C). This horizontal light could be diffused according to the preceding description.

Therefore embodiments as described above would allow placement of downlights 111, FIGS. 9A and 9B, and uplights 114, FIGS. 9B and 9C, at various locations, optimized for player and spectator visibility and visual comfort. Some uplights 114 could be placed in (e.g. behind) berm locations 117 and 118 along the fairways. These locations would particularly benefit from the use of uplights with some form of diffusion to help reduce player or spectator discomfort from harsh LED lighting. Since golf course topography varies with each course, it is important to be able to adapt lighting to variations in grade and other course characteristics. Thus downlighting and uplighting using reflectors, visors, surrounds, or diffusers would all potentially provide benefits for golf course illumination. An option would be to provide downlighting 130 and uplighting 140 with different color temperatures, since downlighting would benefit from specific attention to the area being illuminated, while uplighting is strictly to illuminate the ball in flight.

FIG. 10A illustrates a fixture according to aspects of the invention. LED fixture 211 is mounted 20 feet from the ground on pole 12. It includes LED with secondary lens 210 and surrounds or visors 213 and 214. As illustrated in this exemplary embodiment, it is viewed from location 230, which is a horizontal distance of 20 feet and a vertical distance from the fixture of 14 feet. The angle 220 subtended from location 230 is approximately 1 degree, of which ⅓ is the LED with secondary lens and ⅔ is the visor or luminous (diffusive) surround.

FIG. 10B illustrates a fixture similar to FIG. 10A but with fixture 241 mounted 4 feet from the ground on structure 212, as might be used for uplighting on a golf course as discussed previously. As illustrated in this exemplary embodiment, it is viewed from location 231, which is a horizontal distance of 10 feet and a vertical distance from the fixture of 2 feet. The angle 221 subtended from location 231 is approximately 5.7 degrees, of which ⅓ is the LED with secondary lens 240, ⅓ is upper visor or luminous surround 243, and ⅓ is lower visor or luminous surround 244.

Both FIGS. 10A and 10B illustrate how an embodiment using reflectors, visors, diffusers, or surrounds that provide a significant portion of the available light by diffusion of the near-point source LEDs could provide significant benefits in reduction of intensity and perception of glare by an observer. This is particularly apparent with respect to FIG. 10B, which illustrates a view that a golfer on a course might have of an LED light if the golfer were forced by the play location of the ball to be in quite close proximity to the light source. Apart from this embodiment, the glare would likely be unbearable, making it impossible to play; however with the fixture as shown, while the light might still be unpleasant, it could make it possible to play even at that close proximity to the light source. FIG. 13A-C represents an additional embodiment of a luminaire according to aspects of the invention. One or more fixtures 1011 may be mounted on a pole 1002, FIG. 13A, low and inverted, as compared to other fixtures in array 1000. By pivoting knuckle 200 (FIG. 13C), pivoting visor, e.g., 300. See also FIG. 11A, or 300B and/or 300A, FIG. 13C, changing the slope of surface 102, FIG. 12C (compare 102A versus 102B) to create a different LED aiming angle, changing the angle of reflective strip 503 relative LED modules 500 (compare 503A and B in FIG. 12D), or by adding additional light redirecting means (e.g., reference no. 305, FIG. 12E), nearly any desired spread of light may be achieved; see angle A, FIG. 13A.

### Options and Alternatives

As will be appreciated by those skilled in the art, the foregoing examples are but a few examples and illustrations of forms the invention can take. Variations obvious to those skilled in the art will be included within the invention which is not limited by the specific embodiments described herein.

For example, U.S. 2013/0250556 is but one example of the type of LED light source(s), set or array, or fixtures that could be utilized according to aspects of the invention. It has plural LED sources in a linear array. Top and/or bottom visors for that linear array can function to be diffusive surfaces to reduce the perception of glare from the high intensity LED individual sources as well as cut off and redirect light effectively. As is shown in the above examples, one common embodiment would be the fixture with a top visor/diffusive and reflective surface for downlighting when the fixture is elevated on an elevating structure such as a tall pole. However, addition of the lower visor, such as FIG. 13C, could be used with downlighting. But also, as illustrated in the examples, a fixture with one lower visor could be inverted and utilized for uplighting as an independent fixture. The aspects of the invention contemplate, however, that the same fixture could be used for both downlighting and uplighting. The principles to do so are described in examples above.

The examples of specific fixtures in 11A-13C also show other features that can be used if desired or needed. For example, any of the visors could be adjustable for easy adjustment of cutoff and redirection of light as well as fine tuning of reduction of glare for different viewing angles of the fixture. Other optional features are discussed including such things as plural reflectors in the same fixture, and light blocking members (both regarding forward projecting light and backward projecting light). Another example is partially diffusive optical components including lenses. An important aspect of certain embodiments is that if uplighting is needed, normally only a fraction of the amount of light relative to that needed to illuminate a target area is needed for effective uplighting. This allows a designer to consider either separate, stand-alone uplighting fixtures or possibly getting that lesser amount of light from the same fixtures that produce downlight.

It is to be appreciated however that other configurations of LEDs (type, power, color, arrangement or configuration, primary lens, etc.) can be utilized with aspects of the invention as can other configurations of visors, fixtures, diffusing or reflecting surrounds. The configurations can be scaled up and down relative to those in the examples. FIGS. 11A-13C in US 2013/0250556 give alternatives regarding light blocks, additional visors, reflective surfaces and the like. Others are possible. The configuration of visors, reflective or diffusive surfaces, and other components can vary according to desire or need.

As is also discussed above, individual fixtures can be put together in a system of plural fixtures/elevating structures with common power components and controls. See, for example, U.S. 2006/0176695 A1 incorporated by reference herein in its entirety. A designer can balance factors such as the type of light sources and their original configuration and output, altering that output to be perceived as a bigger source for less glare, and nature or amount of cutoff or redirection of that altered output for effective lighting. The designer can be guided by the examples and principles described earlier herein. This includes the potential for less light sources or cheaper light sources, less fixtures, less elevating structures such as poles and the like, and less energy in operating costs while maintaining effective lighting.

The science of light has subtleties and characteristics that are sometimes elusive. For example, the production of light requires energy use. Wide or large area night time lighting requires considerable amounts of light. Illumination of events like sports, parking lots, roadways, or the like require minimum intensity and uniformity of light across such wide or large areas, and many times at least some of the space above them. Many times such lighting fixtures must be positioned outside the wide or large target area. All of the above implicates use of high-intensity sources and fixtures and power components. It implicates number of light sources, fixtures and elevating structures.

As explained above and also in commonly owned U.S. 2006/0176695 A1, incorporated by reference herein in its entirety, this implicates other issues. Examples are glare light, spill light, energy cost, and capital and maintenance costs for such lighting systems. Some of the factors needed to get enough light to the target or space above are antagonistic to glare, spill and to operating and capital costs. U.S. 2006/0176695 A1 explains how it is not necessarily predictable how to balance these factors.

The present invention addresses such issues in its own ways but with analogous results to U.S. 2006/0176695 A1. It is counter intuitive to diffuse light that you want to control precisely to a distant target. Aspects of the present invention do so to reduce glare issues but also can cut off and redirect light to meet intensity needs at the target or space above the target in an effective way. This can lead to even further benefits. It could implicate the need for less light sources and thus less capital cost. It could mean less elevating structures or less robust elevating structures; again involving possible cost savings. It could also lead to less energy expenses. The counter intuitive benefits of less capital costs and operating costs while meeting requirements for lighting at a target area or space can be realized.

What is claimed is:

1. A method for illumination with a lighting fixture comprising:
a. reducing the amount of light directly visible from an array of LED sources; while
b. maintaining approximately the same amount of light emitted from the fixture,
c. so that the illumination reduces the energy required to illuminate a target area or space by increasing the visual performance of the lighting.

2. The method of claim 1 wherein the reducing step reduces perceived light intensity from the array and fixture and the maintaining step maintains a relatively constant level of illumination from the fixture at the target.

3. The method of claim 1 wherein the reducing step comprises placing a luminous surround visible in conjunction with the array of LED sources.

4. The method of claim 3 wherein wherein the luminous surround subtends, from the point of view of an observer in a target area, one of:
a. approximately the same angle as subtended by the array of LEDs;
b. on the order of 50% of the angle as subtended by the array of LEDs; or
c. on the order of 200% of the angle as subtended by the array of LEDs.

5. The method of claim 3 wherein the fixture subtends a viewing angle, as viewed from a target area, of around one of:
a. 0.25°;
b. 0.5°;
c. 1°;
d. 2°; or
e. 4°.

6. The method of claim 1 for providing illumination of a ball in flight at a target area or space comprising, wherein the illumination provides a low but sufficient level of downlighting with a low but sufficient level of uplighting and having low level of glare and reduced harshness.

7. The method of claim 6 wherein the target area or space comprises a sports field.

8. The method of claim 7 wherein the sports field comprises a golf course.

9. A lighting apparatus comprising:
a. an LED having a light output;
b. a secondary lens in the light output of the LED; and
c. a diffuse reflective surround in the light output of the secondary lens where the diffuse reflective surround comprises an area, in comparison to the area of the LED with its secondary lens, of one of:
10%;
20%;
50%;
100%; or
200% or more.

10. The apparatus of claim 9 for providing illumination of a ball in flight at a target area or space comprising, wherein the illumination provides a low but sufficient level of downlighting with a low but sufficient level of uplighting and having low level of glare and reduced harshness.

11. A method of illuminating a target area or space above the target area comprising:
a. providing a set of one or more solid state light sources each having an original perceived size by persons viewing it when operating and an original light output aimed at the target area or space above the target area ;
b. altering the original perceived size of each of the one or more light sources to an effectively larger light source by at least partially diffusing the original light output effectively increasing the area from which light from the light source projects;
c. cutting off some of the at least partially diffused light to control spill light and glare; and
d. redirecting at least some of the partially diffused light.

12. The method of claim 11 wherein the solid state source comprises an LED.

13. The method of claim 11 wherein the altering is by one or more of:
a. reflecting light from the light source by total or partial reflection;
b. diffusing light from the light source;
c. surrounding the light source with a luminous source of same or different color or color temperature as the light source light output.

14. The method of claim 11 wherein cutting off light is by one or more of:
a. a reflective surface;
b. a blocking surface.

15. The method of claim 11 wherein the redirecting of light is by one or more of:
a. a reflecting surface which redirects at least a portion of light from the light sources to one or more zones;
b. a lens.

16. The method of claim 11 wherein the illuminating is of;
a. a target area;
b. a space above the target area with a fraction of light used for the target; or c. a target area and a space above the target area.

17. The method of claim 16 wherein the target area is a sports field.

18. The method of claim 17 wherein the sports field comprises:
a. a baseball field;
b. a softball field;
c. a soccer field;
d. a football field;
e. a golf course.

19. The method of claim 11 wherein the altering comprises placing the set of one or more light sources in a lighting fixture with a visor at least one of above and below each light source and cutting off a portion of light output from the light source.

20. The method of claim 19 wherein each visor includes a light diffusing or reflective surface.

21. An apparatus for illuminating a target area or space above the target area comprising:
a. a set of one or more solid state light sources each having an original perceived size by persons viewing it when operating and an original light output;
b. a first component associated with the each of the light sources to alter the light output to increase the area from which light projects from the light source; and
c. a second component to cut-off and/or redirect at least some of the altered light output;
d. so that perceived size of the light source is effectively increased to reduce glare to persons viewing it and altered light output places light in a desired area or space.

22. The apparatus of claim 21 wherein the first component comprises:
a. a visor;
b. a reflector;
c. a diffuser;
d. a luminous source surrounding the light source of same or different color or color temperature as the light source light output;
e. a lens.

23. The apparatus of claim 21 wherein the second component comprises:
a. a visor
b. a reflector;
c. a lens;
d. a light block;
e. a combination of any of the above.

24. The apparatus of claim 21 wherein the first and second components comprise one or more visors associated with the light sources, each with a diffusive and/or reflective surface.

25. The apparatus of claim 21 wherein the target space is a sports field.

26. The apparatus of claim 21 wherein the set of light sources is housed in a lighting fixture.

27. The apparatus of claim 26 in combination with a plurality of additional said fixtures positioned at or around the target area.

28. The apparatus of claim 27 further comprising elevating structure and power components for each of the fixtures.

29. The apparatus of claim 28 further comprising a control system for the fixtures and power components to control operation of the light sources.

30. The apparatus of claim 29 wherein the set of light sources in each fixture is arranged in a linear fashion.

31. A method of lighting a sports field comprising:
a. providing down lighting to the sports field from a plurality of solid state light sources, each solid state light source having;
i. a light output modified to effectively increase perceived size of the light source to persons viewing it;
ii. a light output modified to cut-off and redirect what would otherwise be spill light to the sports field;
b. providing up lighting to a space above the sports field from the plurality of solid state light sources or another plurality of solid state light sources, each solid state light source having
i. a light output modified to effectively increase perceived size of the light source to persons viewing it;
c. so that glare is reduced to persons viewing the light sources, spill light is reduced, and light is more effectively used for down lighting and up lighting relative the sports field.

32. The method of claim 31 wherein the down lighting and up lighting are from the same set of solid state light sources.

33. The method of claim 32 wherein one or more solid state light sources from the set produce both some down lighting and some up lighting.

34. The method of claim 33 wherein the one or more solid state light sources include optical components to split light between down lighting and up lighting.

35. The method of claim 31 wherein the down lighting and up lighting are from separate sets of solid state light sources.
